(19) United States
(12) Patent Application Publication
(10) Pub. No.: US 2024/0155503 A1
(43) Pub. Date: May 9, 2024

(54) SPATIAL RELATIONSHIP AND POWER CONTROL CONFIGURATION FOR UPLINK TRANSMISSIONS

(71) Applicant: Intel Corporation, Santa Clara, CA (US)

(72) Inventors: Guotong Wang, Beijing (CN); Alexei Davydov, Nizhny Novgorod (RU); Avik Sengupta, San Jose, CA (US); Bishwarup Mondal, San Ramon, CA (US)

(21) Appl. No.: 18/549,875

(22) PCT Filed: May 9, 2022
(86) PCT No.: PCT/US2022/028335

§ 371 Date: Sep. 8, 2023

Related U.S. Application Data
(60) Provisional application No. 63/186,633, filed on May 10, 2021.
(60) Provisional application No. 63/186,545, filed on May 10, 2021.

(51) Int. Cl. H04W 52/14; H04L 5/00

(52) U.S. Cl. CPC H04W 52/146; H04L 5/0094

(57) ABSTRACT

The present invention is directed to configurations that include spatial relationships and power control settings for uplink transmissions based on different usages (codebook and non-codebook usages), wherein the configuration includes a transmission configuration indicator (TCI) state that includes or associated with a plurality of power control parameters, wherein the association between the TCI and the plurality of power control parameters is updated using a medium access control (MAC) control element (CE), and wherein at least one power control parameter setting in the configuration is common to a plurality of different uplink transmissions.

### CROSS REFERENCE TO RELATED APPLICATION

The present application claims priority to U.S. Provisional Patent Application No. 63/186,633, which was filed May 10, 2021; and to U.S. Provisional Patent Application No. 63/186,545, which was filed May 10, 2021.

### FIELD

Various embodiments generally may relate to the field of wireless communications. For example, some embodiments may relate to configurations that include spatial relationships and power control settings for uplink transmissions based on different usages (e.g., including codebook and non-codebook usages).

### BACKGROUND

In the fifth generation (5G) new radio (NR) Rel-15 specification, different types of sounding reference signal (SRS) resource sets are supported. The SRS resource set is configured with a parameter of ‘usage’, which can be set to ‘beamManagement’, ‘codebook’, ‘nonCodebook’ or ‘antennaSwitching’. The SRS resource set configured for ‘beamManagement’ is used for beam acquisition and uplink beam indication using SRS. The SRS resource set configured for ‘codebook’ and ‘nonCodebook’ is used to determine the uplink (UL) precoding with explicit indication by TPMI (transmission precoding matrix index) or implicit indication by SRI (SRS resource index). Finally, the SRS resource set configured for ‘antennaSwitching’ is used to acquire DL channel state information (CSI) using SRS measurements in the UE by leveraging reciprocity of the channel in TDD systems. For SRS transmission, the time domain behavior could be periodic, semi-persistent or aperiodic. FIG. 1 shows an example of RRC configuration for a SRS resource set and FIGS. 2A and 2B show an example of RRC configuration for an SRS resource.

When a SRS resource set is configured as ‘aperiodic’, the SRS resource set also includes configuration of slot offset (slotOffset) and trigger state(s) (aperiodicSRS-ResourceTrigger, aperiodicSRS-ResourceTriggerList). The parameter of slotOffset defines the slot offset relative to PDCCH where SRS transmission should be commenced. The triggering state(s) defined which DCI codepoint(s) triggers the corresponding SRS resource set transmission.

In Rel-17, joint DL/UL TCI state or separate DL/UL TCI state could be used for beam indication. The TCI state could be delivered over DCI. The power control setting could be associated with TCI state. However, application of a TCI state and corresponding power control setting should consider different SRS usages because the SRS configuration could be different for various SRS usages. Embodiments of the present disclosure address these and other issues.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of an RRC message for SRS resource set configuration in accordance with various embodiments.

FIGS. 2A and 2B illustrate an example of RRC configuration for a SRS resource in accordance with various embodiments.

FIG. 3 illustrates an example of a joint DL/UL TCI state for SRS with antenna switching in accordance with various embodiments.

FIG. 4 illustrates an example of separate DL TCI states for SRS with antenna switching in accordance with various embodiments.

FIG. 5 illustrates an example of separate DL/UL TCI states for SRS with antenna switching in accordance with various embodiments.

FIG. 6 illustrates an example of a TCI state for SRS to refine UE Tx beam in accordance with various embodiments.

FIG. 7 illustrates an example of a TCI state for SRS to refine gNB Rx beam in accordance with various embodiments.

FIGS. 8A and 8B illustrates an example of an application of a TCI state of corresponding power control setting for SRS in accordance with various embodiments.

FIG. 9 illustrates an example of an association between TCI state and power control setting for PUSCH/PUCCH/SRS in accordance with various embodiments.

FIG. 10 schematically illustrates a wireless network in accordance with various embodiments.

FIG. 11 schematically illustrates components of a wireless network in accordance with various embodiments.

FIG. 12 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 13, 14, and 15 depict examples of procedures for practicing the various embodiments discussed herein.

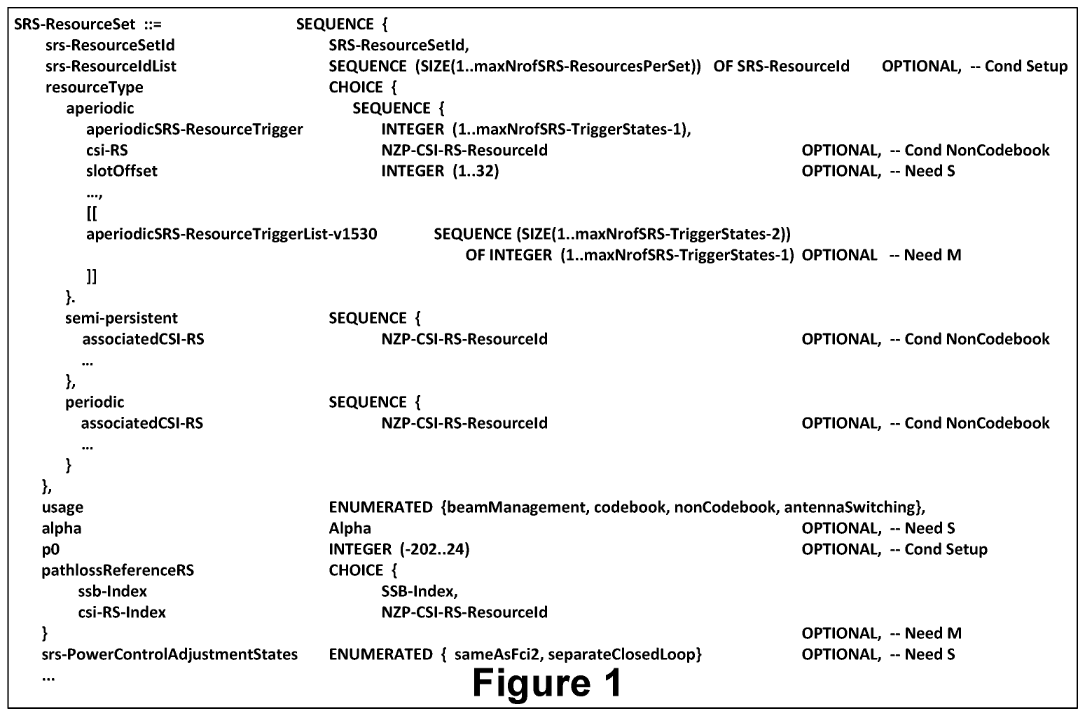

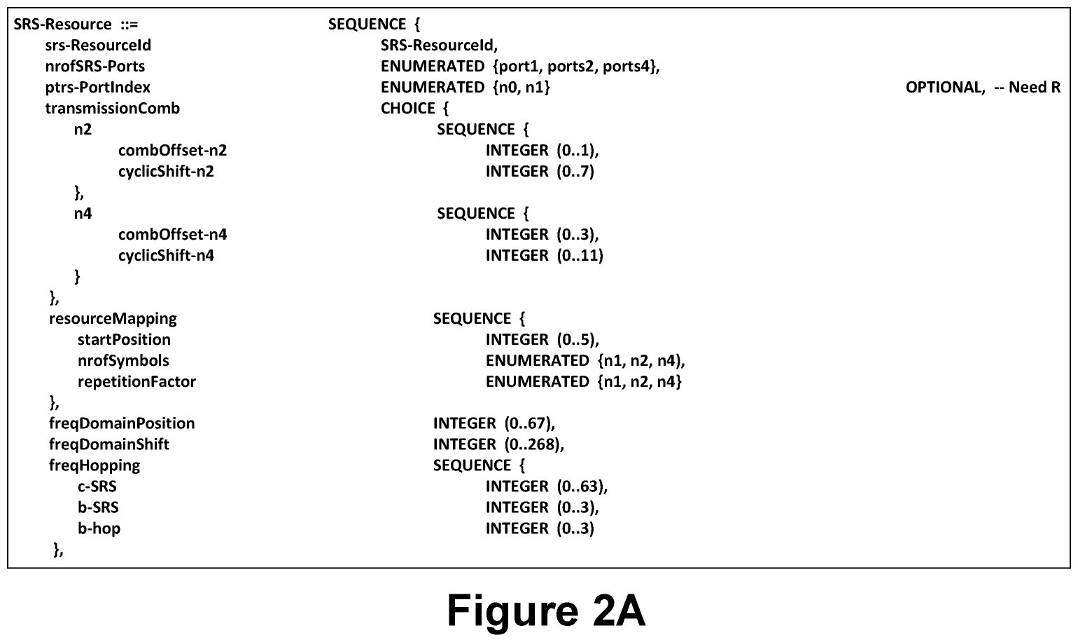

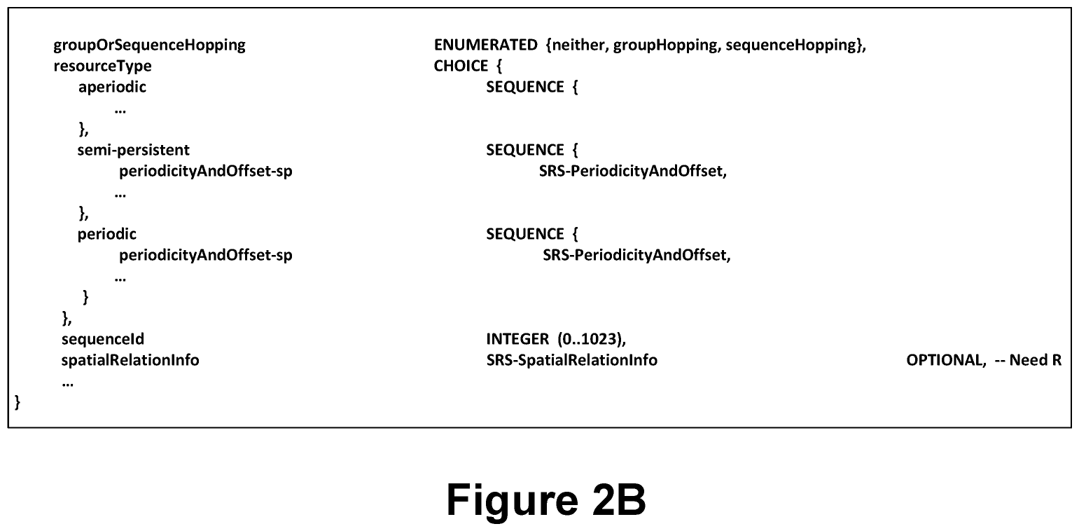

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

As introduced above, the current Rel-17 beam indication and power control setting does not consider different SRS usages. Among other things, various embodiments provide techniques to determine spatial relation and power control setting for SRS considering different SRS usage including antenna switching and beam management.

Scenario #1: SRS with Usage of Antenna Switching

Case A: UE Supports Rel-17 Joint DL UL TCI or Separate DL UL TCI

1) Only One Group of SRS Resource Sets Configured for xTyR in Multi-TRP

In an embodiment, for SRS with antenna switching, only one group of SRS resource sets is configured for certain xTyR configuration in multi-TRP, which means the number of SRS resource sets (including periodic/semi-persistent/aperiodic SRS) for xTyR in multi-TRP is the same as the case of xTyR in single TRP. In this case, multiple (e.g. 2) separate close loop power control states could be configured for SRS (one separate close loop power control state corresponds to one TRP). Or only one separate close loop power control state could be configured for SRS.

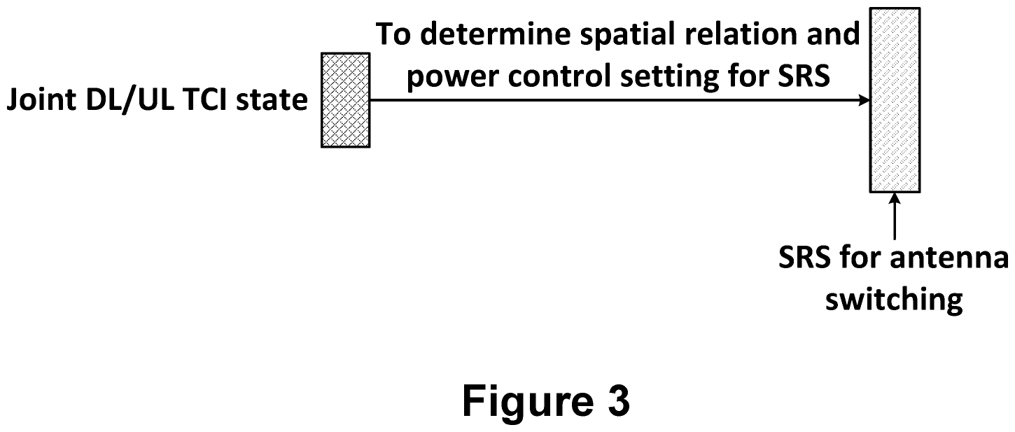

In an embodiment, for SRS with antenna switching, if the UE supports joint DL/UL TCI state, the SRS power control parameter setting (P0, alpha, closed loop power control index/closed loop power control state, pathloss reference signal, etc.) could be associated/included in the joint DL/UL TCI state. The association between TCI state and SRS power control settings could be configured by RRC or updated by MAC-CE. In another example, the pathloss reference signal is configured by RRC or updated by MAC-CE. FIG. 3 shows an example of the operation.

In one example, the UE can be configured with two separate close loop power control states for SRS (e.g. one or some SRS resource sets is configured with the first separate close loop power control state, the other one or some SRS resource sets is configured with the second separate close loop power control state). When the TCI state is indicated via DCI (e.g. DCI format 1_1/1_2 or any other DCI format that can indicate TCI state), the application of TCI state and corresponding power control settings to the SRS resource set is implicitly indicated by the closed loop power control index, e.g. the TCI state and power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI.

In another example, the UE can be configured with only one separate close loop power control state for SRS. When the TCI state is indicated via DCI (e.g. DCI format 1_1/1_2 or any other DCI format that can indicate TCI state), the TCI state and corresponding power control settings will be applied to the future SRS transmission. The SRS resource set could be periodic/semi-persistent/aperiodic. The closed loop power control index for SRS resource set could be configured by RRC and/or updated/changed by MAC-CE or DCI.

In another embodiment, for SRS with antenna switching, if the UE supports separate DL/UL TCI state, the SRS power control parameter setting (P0, alpha, closed loop power control index/closed loop power control state, pathloss reference signal, etc.) could be associated/included in the separate DL TCI state. The association between TCI state and SRS power control settings could be configured by RRC or updated by MAC-CE. In another example, the pathloss reference signal is configured by RRC or updated by MAC-CE.

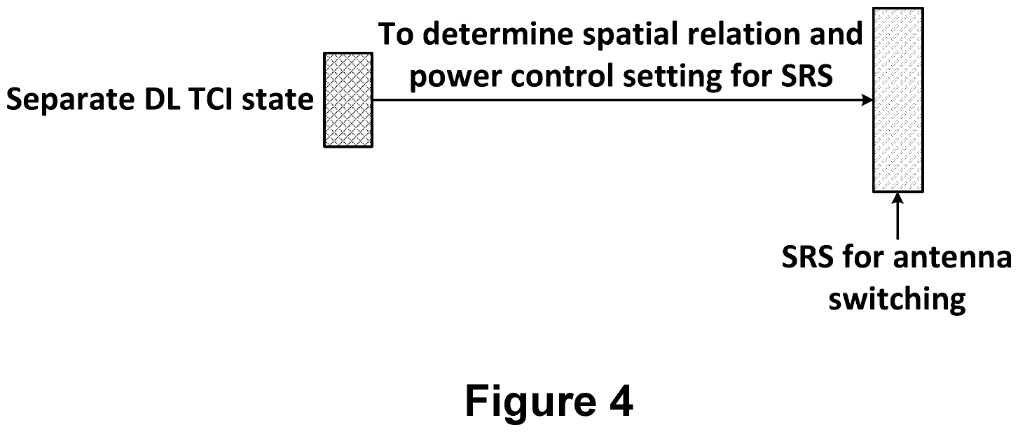

In this case, both spatial relation and power control setting for SRS is obtained from the separate DL TCI state. FIG. 4 shows an example of the operation.

In another embodiment, for SRS with antenna switching, if the UE supports separate DL/UL TCI state, the SRS power control parameter setting (P0, alpha, closed loop power control index/closed loop power control state, pathloss reference signal, etc.) could be associated/included in the separate UL TCI state. The association between TCI state and SRS power control settings could be configured by RRC or updated by MAC-CE. In another example, the pathloss reference signal is configured by RRC or updated by MAC-CE.

For SRS with antenna switching, the spatial relation for SRS is determined by the separate DL TCI state. The power control setting is derived from the separate UL TCI state. FIG. 4 shows an example of the operation.

In one example, the UE can be configured with two separate close loop power control states for SRS (e.g. one or some SRS resource sets is configured with the first separate close loop power control state, the other one or some SRS resource sets is configured with the second separate close loop power control state). The DL TCI state should also be associated with close loop power control index (the association could be implicit or explicit). When the DL TCI state is indicated via DCI (e.g. DCI format 1_1/1_2 or any other DCI format that can indicate TCI state), the application of DL TCI state to the SRS resource set is implicitly indicated by the closed loop power control index, e.g. the TCI state will be applied to the SRS resource set configured with the same closed loop power control index. When the UL TCI state is indicated via DCI (e.g. DCI format 1_1/1_2 or any other DCI format that can indicate TCI state), the application of the corresponding power control settings to the SRS resource set is implicitly indicated by the closed loop power control index, e.g. the power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI.

In another example, the UE can be configured with only one separate close loop power control state for SRS. When the DL TCI state is indicated via DCI (e.g. DCI format 1_1/1_2 or any other DCI format that can indicate TCI state), the TCI state will be applied to the future SRS transmission. When the UL TCI state is indicated via DCI (e.g. DCI format 1_1/1_2 or any other DCI format that can indicate TCI state), the corresponding power control settings will be applied to the future SRS transmission. The SRS resource set could be periodic/semi-persistent/aperiodic.

The closed loop power control index for SRS resource set could be configured by RRC and/or updated/changed by MAC-CE or DCI.

2) Two Groups of SRS Resource Sets Configured for xTyR in Multi-TRP

In an embodiment, for SRS with antenna switching, two groups of SRS resource sets are configured for certain xTyR configuration in multi-TRP, which means the number of SRS resource sets (including periodic/semi-persistent/aperiodic SRS) for xTyR in multi-TRP is doubled as the case of xTyR in single TRP. In this case, multiple (e.g. 2) separate close loop power control states could be configured for SRS (one separate close loop power control state corresponds to one TRP). One group of SRS resource sets is configured with the first close loop power control state. The other group of SRS resource sets is configured with the second close loop power control state. Or only one separate close loop power control state could be configured for SRS.

In an embodiment, for SRS with antenna switching, if the UE supports joint DL/UL TCI state, the SRS power control parameter setting (P0, alpha, closed loop power control index/closed loop power control state, pathloss reference signal, etc.) could be associated/included in the joint DL/UL TCI state. The association between TCI state and SRS power control settings could be configured by RRC or updated by MAC-CE. In another example, the pathloss reference signal is configured by RRC or updated by MAC-CE.

In one example, the UE can be configured with two separate close loop power control states for SRS (e.g., one or some SRS resource sets is configured with the first separate close loop power control state, the other one or some SRS resource sets is configured with the second separate close loop power control state). When the TCI state is indicated via DCI (e.g. DCI format 1_1/1_2 or any other DCI format that can indicate TCI state), the application of TCI state and corresponding power control settings to the SRS resource set is implicitly indicated by the closed loop power control index, e.g. the TCI state and power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI.

In another embodiment, for SRS with antenna switching, if the UE supports separate DL/UL TCI state, the SRS power control parameter setting (P0, alpha, closed loop power control index/closed loop power control state, pathloss reference signal, etc.) could be associated/included in the separate UL TCI state. The association between TCI state and SRS power control settings could be configured by RRC or updated by MAC-CE. In another example, the pathloss reference signal is configured by RRC or updated by MAC-CE.

For SRS with antenna switching, the spatial relation for SRS is determined by the separate DL TCI state. The power control setting is derived from the separate UL TCI state.

In one example, the UE can be configured with two separate close loop power control states for SRS (e.g., one or some SRS resource sets is configured with the first separate close loop power control state, the other one or some SRS resource sets is configured with the second separate close loop power control state). The DL TCI state should also be associated with close loop power control index (the association could be implicit or explicit). When the DL TCI state is indicated via DCI (e.g. DCI format 1_1/1_2 or any other DCI format that can indicate TCI state), the application of DL TCI state to the SRS resource set is implicitly indicated by the closed loop power control index, e.g. the TCI state will be applied to the SRS resource set configured with the same closed loop power control index. When the UL TCI state is indicated via DCI (e.g. DCI format 1_1/1_2 or any other DCI format that can indicate TCI state), the application of the corresponding power control settings to the SRS resource set is implicitly indicated by the closed loop power control index, e.g. the power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI.

In another example, the power control setting for SRS with antenna switching is associated or included in separate DL TCI state. In this case, both spatial relation and power control setting for SRS is obtained from the separate DL TCI state.

### Case B: UE Doesn't Support Rel-17 Joint DL UL TCI or Separate DL UL TCI

In an embodiment, if the UE doesn't support joint DL/UL TCI or separate DL/UL TCI state, the SRS power control parameter setting (P0, alpha, closed loop power control index/closed loop power control state, pathloss reference signal, etc.) could be updated by MAC-CE.

In one example, the MAC-CE could update the power control setting for one or multiple SRS resource sets. The SRS could be periodic/semi-persistent/aperiodic.

In another example, the SRS power control setting could be indicated by DCI. New DCI field could be introduced, or some existing DCI field could be re-used.

In another example, in multi-TRP, for SRS with antenna switching, the UE could be configured with only one group of SRS resource sets for antenna switching or multiple groups of SRS resource sets for antenna switching.

In another example, for SRS in multi-TRP, the UE could be configured with one separate close loop power control state or two separate close loop power control state (e.g. one or some SRS resource sets is configured with the first separate close loop power control state, the other one or some SRS resource sets is configured with the second separate close loop power control state).

Scenario #2: SRS with Usage of Beam Management

### Case A: UE Supports Rel-17 Joint DL UL TCI or Separate DL UL TCI

1) Case A: SRS to Refine UE Tx Beam

In an embodiment, for SRS with beam management, if the UE supports joint DL/UL TCI state, the SRS power control parameter setting (P0, alpha, closed loop power control index/closed loop power control state, pathloss reference signal, etc.) could be associated/included in the joint DL/UL TCI state. The association between TCI state and SRS power control settings could be configured by RRC or updated by MAC-CE. In another example, the pathloss reference signal is configured by RRC or updated by MAC-CE.

In one example, the TCI state is not used to determine the spatial relation if the SRS is to refine UE Tx beam. The TCI state could be used to derive the power control setting for SRS.

In one example, the UE can be configured with two separate close loop power control states for SRS (e.g. one or some SRS resource sets is configured with the first separate close loop power control state, the other one or some SRS resource sets is configured with the second separate close loop power control state). When the TCI state is indicated via DCI (e.g. DCI format 1_1/1_2 or any other DCI format that can indicate TCI state), the application of corresponding power control settings to the SRS resource set is implicitly indicated by the closed loop power control index, e.g., the power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI.

In another example, the UE can be configured with only one separate close loop power control state for SRS. When the TCI state is indicated via DCI (e.g. DCI format 1_1/1_2 or any other DCI format that can indicate TCI state), the power control settings will be applied to the future SRS transmission. The SRS resource set could be periodic/semi-persistent/aperiodic. The closed loop power control index for SRS resource set could be configured by RRC and/or updated/changed by MAC-CE or DCI.

In another embodiment, for SRS with beam management, if the UE supports separate DL/UL TCI state, the SRS power control parameter setting (P0, alpha, closed loop power control index/closed loop power control state, pathloss reference signal, etc.) could be associated/included in the separate UL TCI state. The association between TCI state and SRS power control settings could be configured by RRC or updated by MAC-CE. In another example, the pathloss reference signal is configured by RRC or updated by MAC-CE.

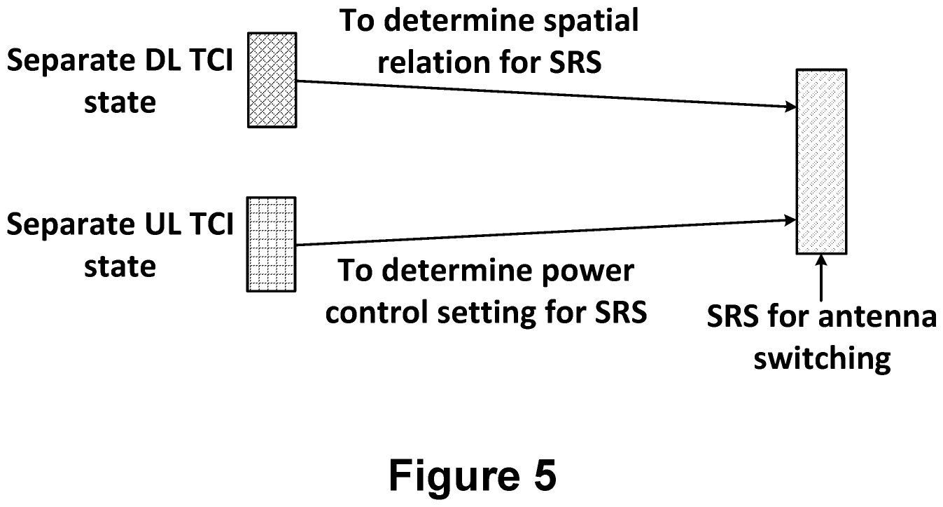

In one example, the separate UL TCI state is not used to determine the spatial relation if the SRS is to refine UE Tx beam. The separate UL TCI state could be used to derive the power control setting for SRS. FIG. 5 shows an example of the operation.

In one example, the UE can be configured with two separate close loop power control states for SRS (e.g. one or some SRS resource sets is configured with the first separate close loop power control state, the other one or some SRS resource sets is configured with the second separate close loop power control state). When the separate UL TCI state is indicated via DCI (e.g. DCI format 1_1/1_2 or any other DCI format that can indicate TCI state), the application of the corresponding power control settings to the SRS resource set is implicitly indicated by the closed loop power control index, e.g. the power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI.

In another example, the UE can be configured with only one separate close loop power control state for SRS. When the separate UL TCI state is indicated via DCI (e.g. DCI format 1_1/1_2 or any other DCI format that can indicate TCI state), the corresponding power control settings will be applied to the future SRS transmission. The SRS resource set could be periodic/semi-persistent/aperiodic. The closed loop power control index for SRS resource set could be configured by RRC and/or updated/changed by MAC-CE or DCI.

2) Case B: SRS to Refine gNB Rx Beam

In an embodiment, for SRS with beam management, if the UE supports joint DL/UL TCI state, the SRS power control parameter setting (P0, alpha, closed loop power control index/closed loop power control state, pathloss reference signal, etc.) could be associated/included in the joint DL/UL TCI state. The association between TCI state and SRS power control settings could be configured by RRC or updated by MAC-CE. In another example, the pathloss reference signal is configured by RRC or updated by MAC-CE.

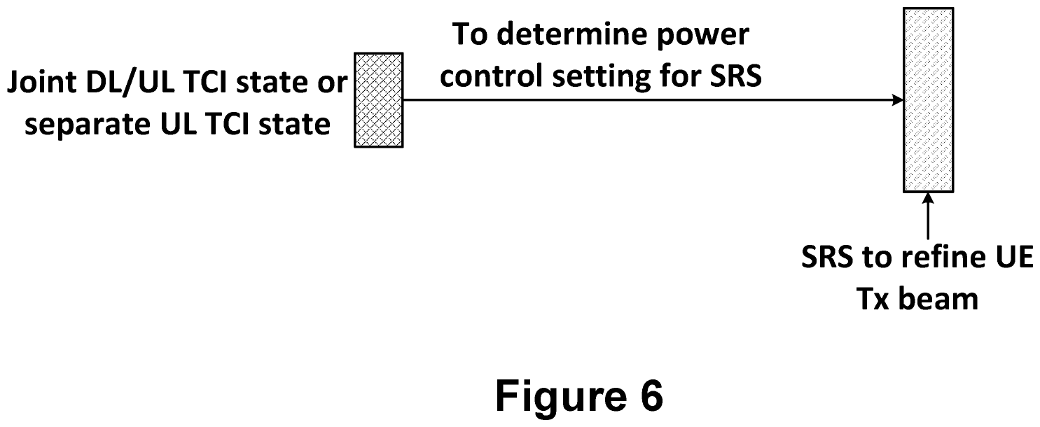

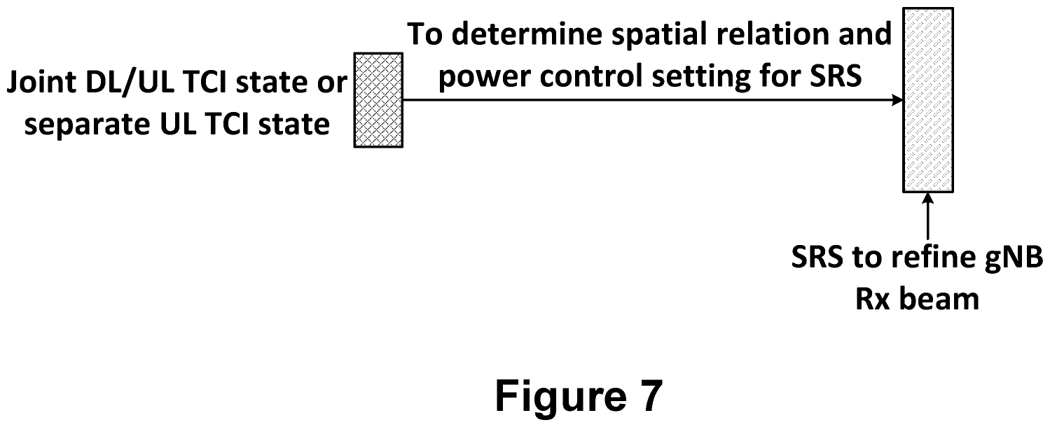

In one example, the TCI state is used to determine the spatial relation if the SRS is to refine gNB Rx beam. The TCI state could also be used to derive the power control setting for SRS. FIG. 6 shows an example of the operation.

In one example, the UE can be configured with two separate close loop power control states for SRS (e.g. one or some SRS resource sets is configured with the first separate close loop power control state, the other one or some SRS resource sets is configured with the second separate close loop power control state). When the TCI state is indicated via DCI (e.g. DCI format 1_1/1_2 or any other DCI format that can indicate TCI state), the application of the TCI state and corresponding power control settings to the SRS resource set is implicitly indicated by the closed loop power control index, e.g. the TCI state and power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI.

In another example, the UE can be configured with only one separate close loop power control state for SRS. When the TCI state is indicated via DCI (e.g. DCI format 1_1/1_2 or any other DCI format that can indicate TCI state), the TCI state and power control settings will be applied to the future SRS transmission. The SRS resource set could be periodic/semi-persistent/aperiodic. The closed loop power control index for SRS resource set could be configured by RRC and/or updated/changed by MAC-CE or DCI.

In another embodiment, for SRS with beam management, if the UE supports separate DL/UL TCI state, the SRS power control parameter setting (P0, alpha, closed loop power control index/closed loop power control state, pathloss reference signal, etc.) could be associated/included in the separate UL TCI state. The association between TCI state and SRS power control settings could be configured by RRC or updated by MAC-CE. In another example, the pathloss reference signal is configured by RRC or updated by MAC-CE.

In one example, the separate UL TCI state is used to determine the spatial relation if the SRS is to refine gNB Rx beam. The separate UL TCI state could be used to derive the power control setting for SRS.

In one example, the UE can be configured with two separate close loop power control states for SRS (e.g. one or some SRS resource sets is configured with the first separate close loop power control state, the other one or some SRS resource sets is configured with the second separate close loop power control state). When the separate UL TCI state is indicated via DCI (e.g. DCI format 1_1/1_2 or any other DCI format that can indicate TCI state), the application of the TCI state and corresponding power control settings to the SRS resource set is implicitly indicated by the closed loop power control index, e.g. the TCI state and power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI.

In another example, the UE can be configured with only one separate close loop power control state for SRS. When the separate UL TCI state is indicated via DCI (e.g. DCI format 1_1/1_2 or any other DCI format that can indicate TCI state), the TCI state and corresponding power control settings will be applied to the future SRS transmission. The SRS resource set could be periodic/semi-persistent/aperiodic. The closed loop power control index for SRS resource set could be configured by RRC and/or updated/changed by MAC-CE or DCI.

### Case B: UE Doesn't Support Rel-17 Joint DL UL TCI or Separate DL UL TCI

In an embodiment, if the UE doesn't support joint DL/UL TCI or separate DL/UL TCI state, the SRS power control parameter setting (P0, alpha, closed loop power control index/closed loop power control state, pathloss reference signal, etc.) could be updated by MAC-CE.

In one example, the MAC-CE could update the power control setting for one or multiple SRS resource sets. The SRS could be periodic/semi-persistent/aperiodic.

In another example, the SRS power control setting could be indicated by DCI. New DCI field could be introduced, or some existing DCI field could be re-used.

In another example, for SRS in multi-TRP, the UE could be configured with one separate close loop power control state or two separate close loop power control state (e.g. one or some SRS resource sets is configured with the first separate close loop power control state, the other one or some SRS resource sets is configured with the second separate close loop power control state).

### Scenario #3: SRS Power Control State Configuration

In an embodiment, in multi-TRP operation, the UE could be configured with multiple separate close loop power control state, e.g. one or some SRS resource sets is configured with the first separate close loop power control state, the other one or some SRS resource sets is configured with the second separate close loop power control state. The separate power control state could be used for any or some specific usage, e.g. antenna switching/beam management, wherein the SRS power control is not tied with PUSCH. The SRS could be periodic/semi-persistent/aperiodic. The different separate close loop power control state corresponds to different TRP. The power control state could be configured by RRC or updated by MAC-CE or changed by DCI.

If the UE supports joint DL/UL TCI state or separate DL/UL TCI state, the TCI state could be sent over any DCI format that can trigger SRS (e.g. DCI 0_1/0_2/1_1/1_2/2_3). In multi-TRP case, two TCI states could be included in the DCI. In another example, one TCI state is included in the DCI.

In another example, the power control setting for SRS could be indicated by a new field added to DCI or by extension/repurposing of some existing DCI field, e.g. open loop power control parameter set indication field.

Note: The embodiments herein may be used for multi-TRP case (including single DCI multi-TRP and multi-DCI multi-TRP) and single TRP case.

This disclosure proceeds by describing some examples of embodiments directed to determining spatial relationships and power control settings for uplink transmissions (such as SRS) considering different usages, including codebook and noncodebook

Scenario #1: SRS with Usage of Codebook

Case A: UE Supports Rel-17 Joint DL UL TCI or Separate DL UL TCI

In an embodiment, for UE supporting joint DL/UL TCI or separate DL/UL TCI state, the SRS power control parameter setting (P0, alpha, closed loop power control index/closed loop power control state, pathloss reference signal, etc.) could be associated/included in the TCI state. The association between TCI state and SRS power control settings could be configured by RRC or updated by MAC-CE. (In one example, the TCI state could be joint DL/UL TCI state or separate UL TCI state.) When the TCI state is indicated via DCI (e.g., DCI format 1_1/1_2 or any other DCI format that can indicate TCI state), the application of TCI state and corresponding power control settings to the SRS resource set is implicitly indicated by the closed loop power control index, e.g. the TCI state and power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI. Similarly, the application of TCI state and corresponding power control settings to PUSCH repetition/PUCCH repetition is implicitly indicated by the closed loop power control index, e.g., the TCI state and power control setting will be applied to the PUSCH repetition/PUCCH repetition with the same closed loop power control index (targeting to the same TRP).

For example, the SRS resource set #A is configured with closed loop index, e.g., #1, by RRC and SRS resource set #B is configured with closed loop index #2. The TCI state and the power control setting associated with closed loop index #1 will be applied to the SRS resource set #A. The TCI state and the power control setting associated with closed loop index #2 will be applied to the SRS resource set #B.

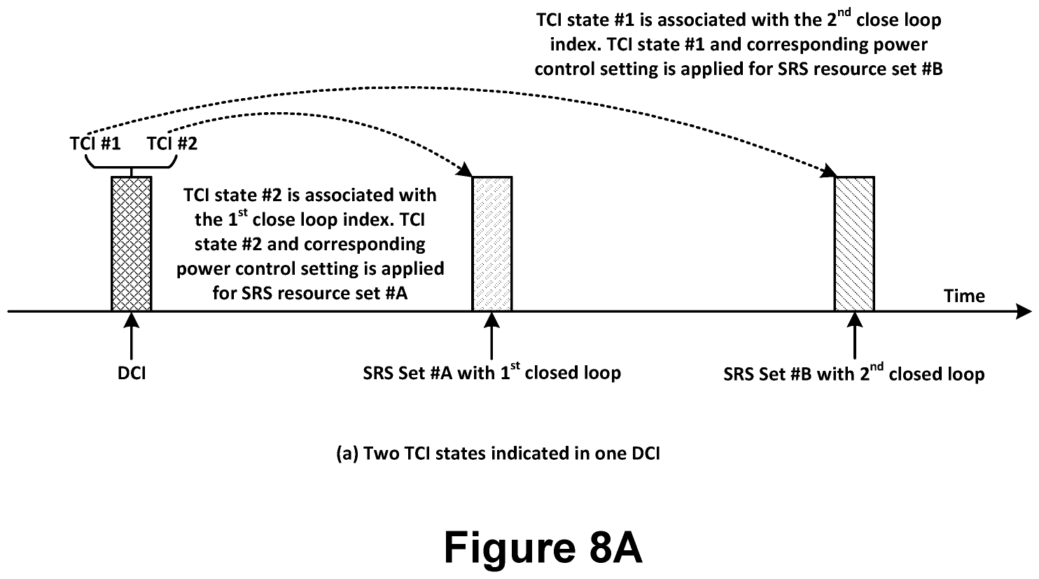

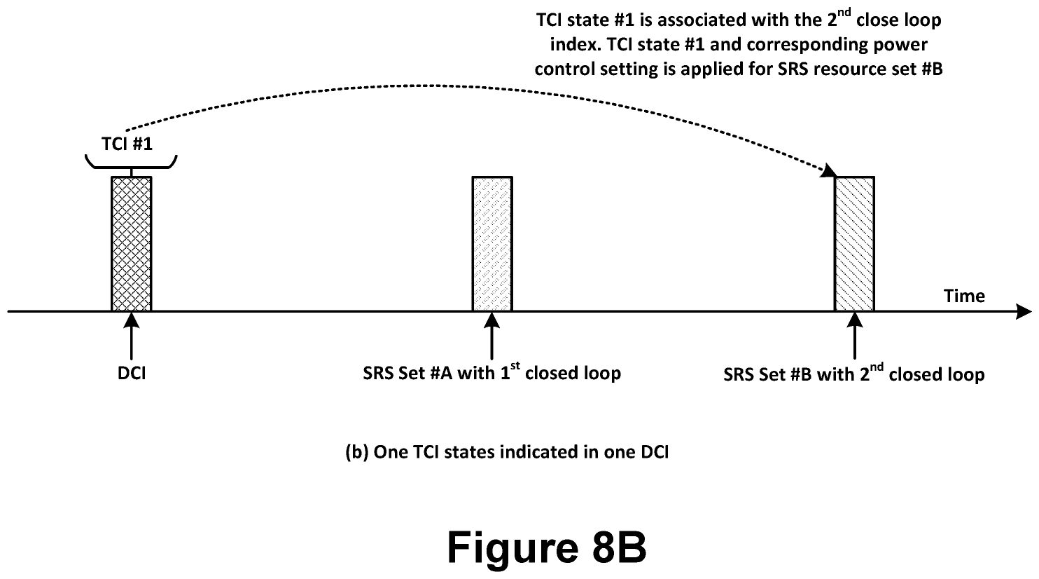

When DCI indicates the TCI state, after the validation period (for example, X slots or X OFDM symbols), then the TCI state and the associated power control setting could be applied for the future PUSCH/PUCCH/SRS transmission. FIGS. 8A and 8B show an example of such an application of a TCI state and corresponding power control setting for SRS in accordance with various embodiments.

In an embodiment, the same TCI state could be associated with or could include different power control parameter settings (P0, alpha, closed loop power control index/closed loop power control state, pathloss reference signal, etc.) for PUSCH/PUCCH/SRS. In this way, when one TCI state is indicated, different parameter settings could be applied for PUSCH, PUCCH and SRS.

In one example, the PUSCH/PUCCH/SRS could be configured with a list of one or several or all the following parameters by RRC (the parameters could be included in one parameter set or split into different parameter set, and RRC configures a list of multiple parameter sets for PUSCH/PUCCH/SRS):
P0 value
alpha value (for PUCCH, there is no parameter of alpha, or alpha is always set to ‘1’ for PUCCH)
closed loop power control index
Pathloss reference signal

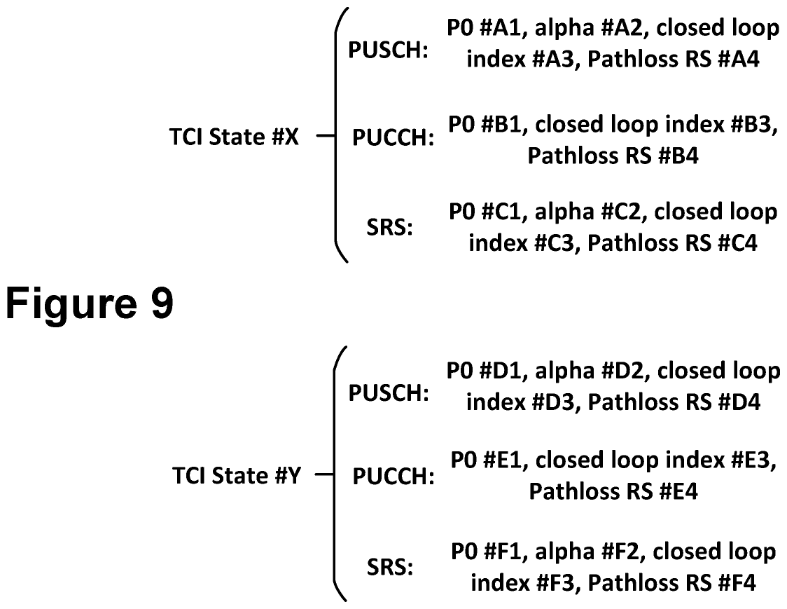

FIG. 9 shows an example of the association between a TCI state and power control setting for PUSCH/PUCCH/SRS.

In one example, MAC-CE could be introduced to update the association between TCI state and the power control parameter settings for PUSCH/PUCCH/SRS.

In another example, the same power control parameter setting could be shared among PUSCH/PUCCH/SRS. For example, SRS and PUSCH can share the same power control parameter setting for the SRS and PUSCH with the same closed loop power control index.

In another embodiment, the power control setting for PUSCH/PUCCH/SRS is not associated with the TCI state. In one example, the TCI state is associated with closed loop power control index. The mapping between TCI state and PUSCH repetition/PUCCH repetition/SRS resource set could be via the close loop index, e.g. the TCI state could be applied for the PUSCH/PUCCH/SRS with the same closed loop index. In another example, the TCI state is implicitly associated with closed loop power control index. For example, in multi-TRP case, the first TCI state in the DCI is implicitly associated with the 1^{st} TRP (the 1^{st} closed loop power control index), and the second TCI state in the DCI is implicitly associated with the 2^{nd} TRP (the 2^{nd} closed loop power control index).

In another example, MAC-CE could be introduced to update the power control setting for one or multiple closed loop power control index for PUSCH/PUCCH/SRS. For example, the MAC-CE can update the P0/alpha/pathloss reference signal setting for the 1^{st} closed loop power control index. For the PUSCH/PUCCH/SRS, the transmission for certain TRP (for certain closed loop power control index) will apply the P0/alpha/pathloss reference signal value as updated by the MAC-CE.

In another example, DCI could be used to indicate which parameter set is used for PUSCH/PUCCH/SRS, for example, a new DCI field could be introduced (it could be introduced into downlink DCI format and/or uplink DCI format). In another example, the power control setting for PUSCH/PUCCH/SRS is indicated by uplink DCI, for example, via the existing open loop power control parameter set indication field or via extension of the existing open loop power control parameter set indication field.

In another embodiment, for UE supporting joint DL/UL TCI or separate DL/UL TCI state, for SRS configured with usage of codebook, up to two different TCI state could be applied for the SRS resources within the same SRS resource set if the number of SRS resources is larger than or equal to 2.

In this case, for the SRS resources within the same SRS resource set, the same closed loop power control index should be configured/indicated.

In another example, the same TCI state should be applied for all the SRS resources within the same SRS resource set for codebook. In this case, except for full power Mode 2, there is no need to configure multiple SRS resources in one SRS resource set for codebook.

### Case B: UE Doesn't Support Rel-17 Joint DL UL TCI or Separate DL UL TCI

In an embodiment, if the UE doesn't support joint DL/UL TCI or separate DL/UL TCI state, the SRS power control parameter setting (P0, alpha, closed loop power control index/closed loop power control state, pathloss reference signal, etc.) could be updated by MAC-CE.

In one example, the MAC-CE could update the power control setting for one or multiple SRS resource sets. The SRS could be periodic/semi-persistent/aperiodic.

In another example, the SRS power control setting could be indicated by DCI. New DCI field could be introduced, or some existing DCI field could be re-used.

Scenario #2: SRS with Usage of nonCodebook

Case A: UE Supports Rel-17 Joint DL UL TCI or Separate DL UL TCI

1) Associated CSI-RS is Configured

In an embodiment, for UE supporting joint DL/UL TCI or separate DL/UL TCI state, the SRS power control parameter setting (P0, alpha, closed loop power control index/closed loop power control state, etc.) could be associated/included in the TCI state. The association between TCI state and SRS power control settings could be configured by RRC or updated by MAC-CE. (In one example, the TCI state could be joint DL/UL TCI state or separate UL TCI state.) When the TCI state is indicated via DCI (e.g. DCI format 1_1/1_2 or any other DCI format that can indicate TCI state), the application of TCI state and corresponding power control settings to the SRS resource set is implicitly indicated by the closed loop power control index, e.g. the TCI state and power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI.

For example, the SRS resource set #A is configured with closed loop index, e.g. #1, by RRC and SRS resource set #B is configured with closed loop index #2. The TCI state and the power control setting associated with closed loop index #1 will be applied to the SRS resource set #A. The TCI state and the power control setting associated with closed loop index #2 will be applied to the SRS resource set #B.

When DCI indicates the TCI state, after the validation period (for example, X slots or X OFDM symbols), then the TCI state and the associated power control setting could be applied for the future PUSCH/PUCCH/SRS transmission.

In one example, for non-codebook SRS configured with associated CSI-RS, the TCI state is not applied for beam indication for the non-codebook SRS, and the TCI state is used to derive the power control parameter setting for non-codebook SRS.

In another embodiment, for non-codebook SRS, the pathloss reference signal could be the associated CSI-RS or could be QCLed with the associated with the associated CSI-RS. The pathloss reference signal could be RRC configured and updated by MAC-CE. Or the pathloss reference signal for SRS could also be associated with the TCI state.

In an embodiment, the same TCI state could be associated with or could include different power control parameter settings (P0, alpha, closed loop power control index/closed loop power control state, etc.) for PUSCH/PUCCH/SRS. In this way, when one TCI state is indicated, different parameter settings could be applied for PUSCH, PUCCH and SRS.

In one example, the PUSCH/PUCCH/SRS could be configured with a list of one or several or all the following parameters by RRC (the parameters could be included in one parameter set or split into different parameter set, and RRC configures a list of multiple parameter sets for PUSCH/PUCCH/SRS):
P0 value
alpha value (for PUCCH, there is no parameter of alpha, or alpha is always set to ‘1’ for PUCCH)
closed loop power control index
Pathloss reference signal (not for the non-codebook SRS configured with associated CSI-RS)

In one example, MAC-CE could be introduced to update the association between TCI state and the power control parameter settings for PUSCH/PUCCH/SRS.

In another example, the same power control parameter setting could be shared among PUSCH/PUCCH/SRS. For example, SRS and PUSCH can share the same power control parameter setting for the SRS and PUSCH with the same closed loop power control index.

In another embodiment, the power control setting for PUSCH/PUCCH/SRS is not associated with the TCI state. In one example, the TCI state is associated with closed loop power control index. The mapping between TCI state and PUSCH repetition/PUCCH repetition/SRS resource set could be via the close loop index, e.g. the TCI state could be applied for the PUSCH/PUCCH/SRS with the same closed loop index. In another example, the TCI state is implicitly associated with closed loop power control index. For example, in multi-TRP case, the first TCI state in the DCI is implicitly associated with the 1^{st} TRP (the 1^{st} closed loop power control index), and the second TCI state in the DCI is implicitly associated with the 2^{nd} TRP (the 2^{nd} closed loop power control index).

In another example, MAC-CE could be introduced to update the power control setting for one or multiple closed loop power control index for PUSCH/PUCCH/SRS. For example, the MAC-CE can update the P0/alpha/pathloss reference signal setting for the 1^{st} closed loop power control index. For the PUSCH/PUCCH/SRS, the transmission for certain TRP (for certain closed loop power control index) will apply the P0/alpha/pathloss reference signal value as updated by the MAC-CE.

In another example, DCI could be used to indicate which parameter set is used for PUSCH/PUCCH/SRS, for example, a new DCI field could be introduced (it could be introduced into downlink DCI format and/or uplink DCI format). In another example, the power control setting for PUSCH/PUCCH/SRS is indicated by uplink DCI, for example, via the existing open loop power control parameter set indication field or via extension of the existing open loop power control parameter set indication field.

2) Associated CSI-RS is not Configured

In an embodiment, for UE supporting joint DL/UL TCI or separate DL/UL TCI state, the SRS power control parameter setting (P0, alpha, closed loop power control index/closed loop power control state, pathloss reference signal, etc.) could be associated/included in the TCI state. The association between TCI state and SRS power control settings could be configured by RRC or updated by MAC-CE. (In one example, the TCI state could be joint DL/UL TCI state or separate UL TCI state.) When the TCI state is indicated via DCI (e.g. DCI format 1_1/1_2 or any other DCI format that can indicate TCI state), the application of TCI state and corresponding power control settings to the SRS resource set is implicitly indicated by the closed loop power control index, e.g. the TCI state and power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI.

For example, the SRS resource set #A is configured with closed loop index, e.g. #1, by RRC and SRS resource set #B is configured with closed loop index #2. The TCI state and the power control setting associated with closed loop index #1 will be applied to the SRS resource set #A. The TCI state and the power control setting associated with closed loop index #2 will be applied to the SRS resource set #B.

When DCI indicates the TCI state, after the validation period (for example, X slots or X OFDM symbols), then the TCI state and the associated power control setting could be applied for the future PUSCH/PUCCH/SRS transmission.

In an embodiment, the same TCI state could be associated with or could include different power control parameter settings (P0, alpha, closed loop power control index/closed loop power control state, pathloss reference signal, etc.) for PUSCH/PUCCH/SRS. In this way, when one TCI state is indicated, different parameter settings could be applied for PUSCH, PUCCH and SRS.

In one example, the PUSCH/PUCCH/SRS could be configured with a list of one or several or all the following parameters by RRC (the parameters could be included in one parameter set or split into different parameter set, and RRC configures a list of multiple parameter sets for PUSCH/PUCCH/SRS):
P0 value
alpha value (for PUCCH, there is no parameter of alpha, or alpha is always set to ‘1’ for PUCCH)
closed loop power control index
Pathloss reference signal

In one example, MAC-CE could be introduced to update the association between TCI state and the power control parameter settings for PUSCH/PUCCH/SRS.

In another example, the same power control parameter setting could be shared among PUSCH/PUCCH/SRS. For example, SRS and PUSCH can share the same power control parameter setting for the SRS and PUSCH with the same closed loop power control index.

In another embodiment, the power control setting for PUSCH/PUCCH/SRS is not associated with the TCI state. In one example, the TCI state is associated with closed loop power control index. The mapping between TCI state and PUSCH repetition/PUCCH repetition/SRS resource set could be via the close loop index, e.g. the TCI state could be applied for the PUSCH/PUCCH/SRS with the same closed loop index. In another example, the TCI state is implicitly associated with closed loop power control index. For example, in multi-TRP case, the first TCI state in the DCI is implicitly associated with the 1^{st} TRP (the 1^{st} closed loop power control index), and the second TCI state in the DCI is implicitly associated with the 2^{nd} TRP (the 2^{nd} closed loop power control index).

In another example, MAC-CE could be introduced to update the power control setting for one or multiple closed loop power control index for PUSCH/PUCCH/SRS. For example, the MAC-CE can update the P0/alpha/pathloss reference signal setting for the 1^{st} closed loop power control index. For the PUSCH/PUCCH/SRS, the transmission for certain TRP (for certain closed loop power control index) will apply the P0/alpha/pathloss reference signal value as updated by the MAC-CE.

In another example, DCI could be used to indicate which parameter set is used for PUSCH/PUCCH/SRS, for example, a new DCI field could be introduced (it could be introduced into downlink DCI format and/or uplink DCI format). In another example, the power control setting for PUSCH/PUCCH/SRS is indicated by uplink DCI, for example, via the existing open loop power control parameter set indication field or via extension of the existing open loop power control parameter set indication field.

Note: the embodiments in this section could also be used for the case that associated CSI-RS is configured for non-codebook SRS.

### Case B: UE Doesn't Support Rel-17 Joint DL UL TCI or Separate DL UL TCI

In an embodiment, if the UE doesn't support joint DL/UL TCI or separate DL/UL TCI state, the SRS power control parameter setting (P0, alpha, closed loop power control index/closed loop power control state, pathloss reference signal, etc.) could be updated by MAC-CE.

In one example, the MAC-CE could update the power control setting for one or multiple SRS resource sets. The SRS could be periodic/semi-persistent/aperiodic.

In another example, the SRS power control setting could be indicated by DCI. New DCI field could be introduced, or some existing DCI field could be re-used.

Note: The embodiments described herein may be used for multi-TRP case (including single DCI multi-TRP and multi-DCI multi-TRP) and single TRP case.

### Systems and Implementations

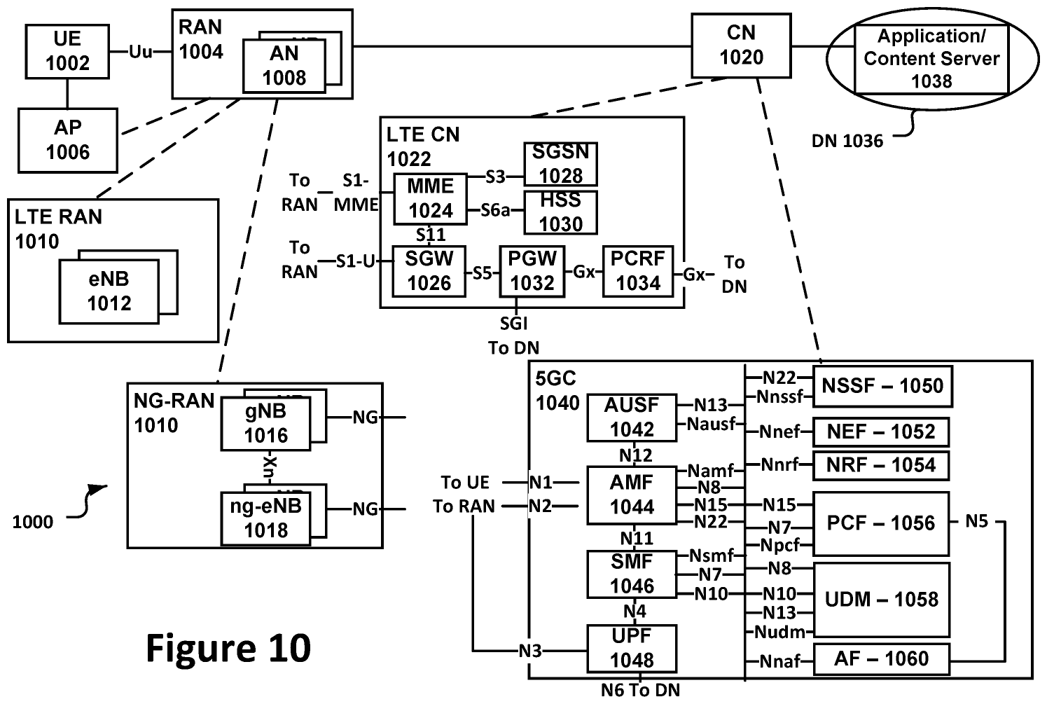

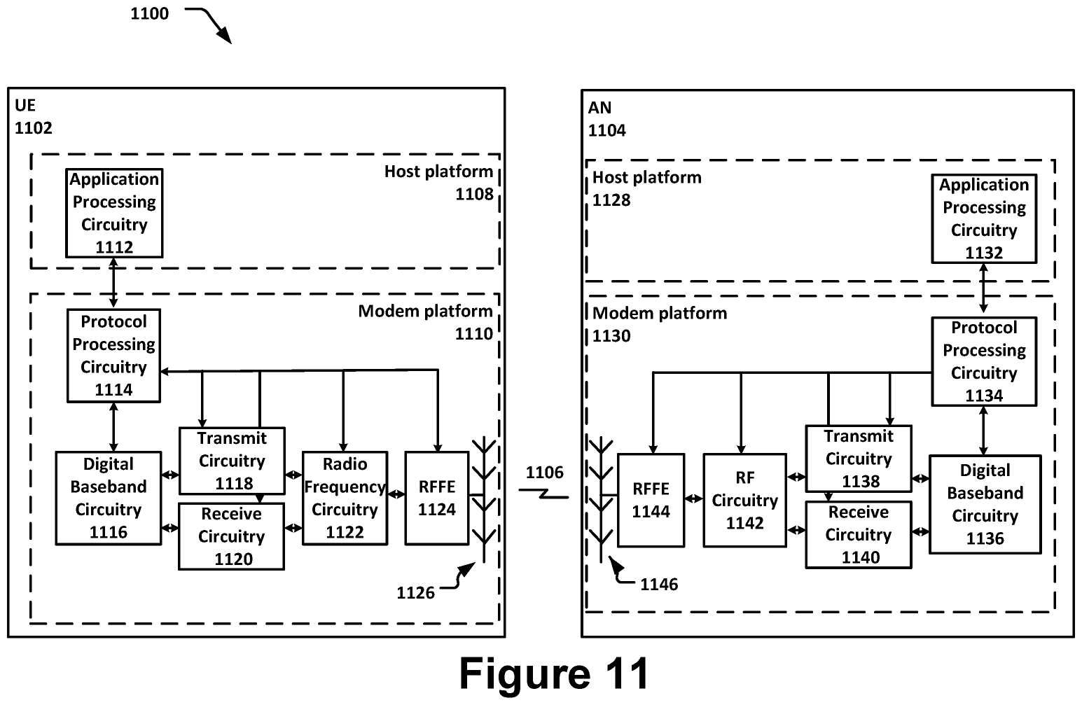

FIGS. 10-11 illustrate various systems, devices, and components that may implement aspects of disclosed embodiments.

FIG. 10 illustrates a network 1000 in accordance with various embodiments. The network 1000 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1000 may include a UE 1002, which may include any mobile or non-mobile computing device designed to communicate with a RAN 1004 via an over-the-air connection. The UE 1002 may be communicatively coupled with the RAN 1004 by a Uu interface. The UE 1002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1002 may additionally communicate with an AP 1006 via an over-the-air connection. The AP 1006 may manage a WLAN connection, which may serve to offload some/all network traffic from the RAN 1004. The connection between the UE 1002 and the AP 1006 may be consistent with any IEEE 802.11 protocol, wherein the AP 1006 could be a wireless fidelity (Wi-Fi®) router. In some embodiments, the UE 1002, RAN 1004, and AP 1006 may utilize cellular-WLAN aggregation (for example, LWA/LWIP). Cellular-WLAN aggregation may involve the UE 1002 being configured by the RAN 1004 to utilize both cellular radio resources and WLAN resources.

The RAN 1004 may include one or more access nodes, for example, AN 1008. AN 1008 may terminate air-interface protocols for the UE 1002 by providing access stratum protocols including RRC, PDCP, RLC, MAC, and L1 protocols. In this manner, the AN 1008 may enable data/voice connectivity between CN 1020 and the UE 1002. In some embodiments, the AN 1008 may be implemented in a discrete device or as one or more software entities running on server computers as part of, for example, a virtual network, which may be referred to as a CRAN or virtual baseband unit pool. The AN 1008 be referred to as a BS, gNB, RAN node, eNB, ng-eNB, NodeB, RSU, TRxP, TRP, etc. The AN 1008 may be a macrocell base station or a low power base station for providing femtocells, picocells or other like cells having smaller coverage areas, smaller user capacity, or higher bandwidth compared to macrocells.

In embodiments in which the RAN 1004 includes a plurality of ANs, they may be coupled with one another via an X2 interface (if the RAN 1004 is an LTE RAN) or an Xn interface (if the RAN 1004 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1004 may each manage one or more cells, cell groups, component carriers, etc. to provide the UE 1002 with an air interface for network access. The UE 1002 may be simultaneously connected with a plurality of cells provided by the same or different ANs of the RAN 1004. For example, the UE 1002 and RAN 1004 may use carrier aggregation to allow the UE 1002 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1004 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1002 or AN 1008 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1004 may be an LTE RAN 1010 with eNBs, for example, eNB 1012. The LTE RAN 1010 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1004 may be an NG-RAN 1014 with gNBs, for example, gNB 1016, or ng-eNBs, for example, ng-eNB 1018. The gNB 1016 may connect with 5G-enabled UEs using a 5GNR interface. The gNB 1016 may connect with a 5G core through an NG interface, which may include an N2 interface or an N3 interface. The ng-eNB 1018 may also connect with the 5G core through an NG interface, but may connect with a UE via an LTE air interface. The gNB 1016 and the ng-eNB 1018 may connect with each other over an Xn interface.

In some embodiments, the NG interface may be split into two parts, an NG user plane (NG-U) interface, which carries traffic data between the nodes of the NG-RAN 1014 and a UPF 1048 (e.g., N3 interface), and an NG control plane (NG-C) interface, which is a signaling interface between the nodes of the NG-RAN 1014 and an AMF 1044 (e.g., N2 interface).

The NG-RAN 1014 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1002 can be configured with multiple BWPs where each BWP configuration has a different SCS. When a BWP change is indicated to the UE 1002, the SCS of the transmission is changed as well. Another use case example of BWP is related to power saving. In particular, multiple BWPs can be configured for the UE 1002 with different amount of frequency resources (for example, PRBs) to support data transmission under different traffic loading scenarios. A BWP containing a smaller number of PRBs can be used for data transmission with small traffic load while allowing power saving at the UE 1002 and in some cases at the gNB 1016. A BWP containing a larger number of PRBs can be used for scenarios with higher traffic load.

The RAN 1004 is communicatively coupled to CN 1020 that includes network elements to provide various functions to support data and telecommunications services to customers/subscribers (for example, users of UE 1002). The components of the CN 1020 may be implemented in one physical node or separate physical nodes. In some embodiments, NFV may be utilized to virtualize any or all of the functions provided by the network elements of the CN 1020 onto physical compute/storage resources in servers, switches, etc. A logical instantiation of the CN 1020 may be referred to as a network slice, and a logical instantiation of a portion of the CN 1020 may be referred to as a network sub-slice.

In some embodiments, the CN 1020 may be an LTE CN 1022, which may also be referred to as an EPC. The LTE CN 1022 may include MME 1024, SGW 1026, SGSN 1028, HSS 1030, PGW 1032, and PCRF 1034 coupled with one another over interfaces (or “reference points”) as shown. Functions of the elements of the LTE CN 1022 may be briefly introduced as follows.

The MME 1024 may implement mobility management functions to track a current location of the UE 1002 to facilitate paging, bearer activation/deactivation, handovers, gateway selection, authentication, etc.

The SGW 1026 may terminate an Si interface toward the RAN and route data packets between the RAN and the LTE CN 1022. The SGW 1026 may be a local mobility anchor point for inter-RAN node handovers and also may provide an anchor for inter-3GPP mobility. Other responsibilities may include lawful intercept, charging, and some policy enforcement.

The SGSN 1028 may track a location of the UE 1002 and perform security functions and access control. In addition, the SGSN 1028 may perform inter-EPC node signaling for mobility between different RAT networks; PDN and S-GW selection as specified by MME 1024; MME selection for handovers; etc. The S3 reference point between the MME 1024 and the SGSN 1028 may enable user and bearer information exchange for inter-3GPP access network mobility in idle/active states.

The HSS 1030 may include a database for network users, including subscription-related information to support the network entities' handling of communication sessions. The HSS 1030 can provide support for routing/roaming, authentication, authorization, naming/addressing resolution, location dependencies, etc. An S6a reference point between the HSS 1030 and the MME 1024 may enable transfer of subscription and authentication data for authenticating/authorizing user access to the LTE CN 1020.

The PGW 1032 may terminate an SGi interface toward a data network (DN) 1036 that may include an application/content server 1038. The PGW 1032 may route data packets between the LTE CN 1022 and the data network 1036. The PGW 1032 may be coupled with the SGW 1026 by an S5 reference point to facilitate user plane tunneling and tunnel management. The PGW 1032 may further include a node for policy enforcement and charging data collection (for example, PCEF). Additionally, the SGi reference point between the PGW 1032 and the data network 1036 may be an operator external public, a private PDN, or an intra-operator packet data network, for example, for provision of IMS services. The PGW 1032 may be coupled with a PCRF 1034 via a Gx reference point.

The PCRF 1034 is the policy and charging control element of the LTE CN 1022. The PCRF 1034 may be communicatively coupled to the app/content server 1038 to determine appropriate QoS and charging parameters for service flows. The PCRF 1032 may provision associated rules into a PCEF (via Gx reference point) with appropriate TFT and QCI.

In some embodiments, the CN 1020 may be a 5GC 1040. The 5GC 1040 may include an AUSF 1042, AMF 1044, SMF 1046, UPF 1048, NSSF 1050, NEF 1052, NRF 1054, PCF 1056, UDM 1058, and AF 1060 coupled with one another over interfaces (or “reference points”) as shown. Functions of the elements of the 5GC 1040 may be briefly introduced as follows.

The AUSF 1042 may store data for authentication of UE 1002 and handle authentication-related functionality. The AUSF 1042 may facilitate a common authentication framework for various access types. In addition to communicating with other elements of the 5GC 1040 over reference points as shown, the AUSF 1042 may exhibit an Nausf service-based interface.

The AMF 1044 may allow other functions of the 5GC 1040 to communicate with the UE 1002 and the RAN 1004 and to subscribe to notifications about mobility events with respect to the UE 1002. The AMF 1044 may be responsible for registration management (for example, for registering UE 1002), connection management, reachability management, mobility management, lawful interception of AMF-related events, and access authentication and authorization. The AMF 1044 may provide transport for SM messages between the UE 1002 and the SMF 1046, and act as a transparent proxy for routing SM messages. AMF 1044 may also provide transport for SMS messages between UE 1002 and an SMSF. AMF 1044 may interact with the AUSF 1042 and the UE 1002 to perform various security anchor and context management functions. Furthermore, AMF 1044 may be a termination point of a RAN CP interface, which may include or be an N2 reference point between the RAN 1004 and the AMF 1044; and the AMF 1044 may be a termination point of NAS (N1) signaling, and perform NAS ciphering and integrity protection.

AMF 1044 may also support NAS signaling with the UE 1002 over an N3 IWF interface.

The SMF 1046 may be responsible for SM (for example, session establishment, tunnel management between UPF 1048 and AN 1008); UE IP address allocation and management (including optional authorization); selection and control of UP function; configuring traffic steering at UPF 1048 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1044 over N2 to AN 1008; and determining SSC mode of a session. SM may refer to management of a PDU session, and a PDU session or “session” may refer to a PDU connectivity service that provides or enables the exchange of PDUs between the UE 1002 and the data network 1036.

The UPF 1048 may act as an anchor point for intra-RAT and inter-RAT mobility, an external PDU session point of interconnect to data network 1036, and a branching point to support multi-homed PDU session. The UPF 1048 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1048 may include an uplink classifier to support routing traffic flows to a data network.

The NSSF 1050 may select a set of network slice instances serving the UE 1002. The NSSF 1050 may also determine allowed NSSAI and the mapping to the subscribed S-NSSAIs, if needed. The NSSF 1050 may also determine the AMF set to be used to serve the UE 1002, or a list of candidate AMFs based on a suitable configuration and possibly by querying the NRF 1054. The selection of a set of network slice instances for the UE 1002 may be triggered by the AMF 1044 with which the UE 1002 is registered by interacting with the NSSF 1050, which may lead to a change of AMF. The NSSF 1050 may interact with the AMF 1044 via an N22 reference point; and may communicate with another NSSF in a visited network via an N31 reference point (not shown). Additionally, the NSSF 1050 may exhibit an Nnssf service-based interface.

The NEF 1052 may securely expose services and capabilities provided by 3GPP network functions for third party, internal exposure/re-exposure, AFs (e.g., AF 1060), edge computing or fog computing systems, etc. In such embodiments, the NEF 1052 may authenticate, authorize, or throttle the AFs. NEF 1052 may also translate information exchanged with the AF 1060 and information exchanged with internal network functions. For example, the NEF 1052 may translate between an AF-Service-Identifier and an internal 5GC information. NEF 1052 may also receive information from other NFs based on exposed capabilities of other NFs. This information may be stored at the NEF 1052 as structured data, or at a data storage NF using standardized interfaces. The stored information can then be re-exposed by the NEF 1052 to other NFs and AFs, or used for other purposes such as analytics. Additionally, the NEF 1052 may exhibit an Nnef service-based interface.

The NRF 1054 may support service discovery functions, receive NF discovery requests from NF instances, and provide the information of the discovered NF instances to the NF instances. NRF 1054 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1054 may exhibit the Nnrf service-based interface.

The PCF 1056 may provide policy rules to control plane functions to enforce them, and may also support unified policy framework to govern network behavior. The PCF 1056 may also implement a front end to access subscription information relevant for policy decisions in a UDR of the UDM 1058. In addition to communicating with functions over reference points as shown, the PCF 1056 exhibit an Npcf service-based interface.

The UDM 1058 may handle subscription-related information to support the network entities' handling of communication sessions, and may store subscription data of UE 1002. For example, subscription data may be communicated via an N8 reference point between the UDM 1058 and the AMF 1044. The UDM 1058 may include two parts, an application front end and a UDR. The UDR may store subscription data and policy data for the UDM 1058 and the PCF 1056, and/or structured data for exposure and application data (including PFDs for application detection, application request information for multiple UEs 1002) for the NEF 1052. The Nudr service-based interface may be exhibited by the UDR 221 to allow the UDM 1058, PCF 1056, and NEF 1052 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1058 may exhibit the Nudm service-based interface.

The AF 1060 may provide application influence on traffic routing, provide access to NEF, and interact with the policy framework for policy control.

In some embodiments, the 5GC 1040 may enable edge computing by selecting operator/3^{rd} party services to be geographically close to a point that the UE 1002 is attached to the network. This may reduce latency and load on the network. To provide edge-computing implementations, the 5GC 1040 may select a UPF 1048 close to the UE 1002 and execute traffic steering from the UPF 1048 to data network 1036 via the N6 interface. This may be based on the UE subscription data, UE location, and information provided by the AF 1060. In this way, the AF 1060 may influence UPF (re)selection and traffic routing. Based on operator deployment, when AF 1060 is considered to be a trusted entity, the network operator may permit AF 1060 to interact directly with relevant NFs. Additionally, the AF 1060 may exhibit an Naf service-based interface.

The data network 1036 may represent various network operator services, Internet access, or third party services that may be provided by one or more servers including, for example, application/content server 1038.

FIG. 11 schematically illustrates a wireless network 1100 in accordance with various embodiments. The wireless network 1100 may include a UE 1102 in wireless communication with an AN 1104. The UE 1102 and AN 1104 may be similar to, and substantially interchangeable with, like-named components described elsewhere herein.

The UE 1102 may be communicatively coupled with the AN 1104 via connection 1106. The connection 1106 is illustrated as an air interface to enable communicative coupling, and can be consistent with cellular communications protocols such as an LTE protocol or a 5G NR protocol operating at mmWave or sub-6 GHz frequencies.

The UE 1102 may include a host platform 1108 coupled with a modem platform 1110. The host platform 1108 may include application processing circuitry 1112, which may be coupled with protocol processing circuitry 1114 of the modem platform 1110. The application processing circuitry 1112 may run various applications for the UE 1102 that source/sink application data. The application processing circuitry 1112 may further implement one or more layer operations to transmit/receive application data to/from a data network. These layer operations may include transport (for example UDP) and Internet (for example, IP) operations The protocol processing circuitry 1114 may implement one or more of layer operations to facilitate transmission or reception of data over the connection 1106. The layer operations implemented by the protocol processing circuitry 1114 may include, for example, MAC, RLC, PDCP, RRC and NAS operations.

The modem platform 1110 may further include digital baseband circuitry 1116 that may implement one or more layer operations that are “below” layer operations performed by the protocol processing circuitry 1114 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1110 may further include transmit circuitry 1118, receive circuitry 1120, RF circuitry 1122, and RF front end (RFFE) 1124, which may include or connect to one or more antenna panels 1126. Briefly, the transmit circuitry 1118 may include a digital-to-analog converter, mixer, intermediate frequency (IF) components, etc.; the receive circuitry 1120 may include an analog-to-digital converter, mixer, IF components, etc.; the RF circuitry 1122 may include a low-noise amplifier, a power amplifier, power tracking components, etc.; RFFE 1124 may include filters (for example, surface/bulk acoustic wave filters), switches, antenna tuners, beamforming components (for example, phase-array antenna components), etc. The selection and arrangement of the components of the transmit circuitry 1118, receive circuitry 1120, RF circuitry 1122, RFFE 1124, and antenna panels 1126 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1114 may include one or more instances of control circuitry (not shown) to provide control functions for the transmit/receive components.

A UE reception may be established by and via the antenna panels 1126, RFFE 1124, RF circuitry 1122, receive circuitry 1120, digital baseband circuitry 1116, and protocol processing circuitry 1114. In some embodiments, the antenna panels 1126 may receive a transmission from the AN 1104 by receive-beamforming signals received by a plurality of antennas/antenna elements of the one or more antenna panels 1126.

A UE transmission may be established by and via the protocol processing circuitry 1114, digital baseband circuitry 1116, transmit circuitry 1118, RF circuitry 1122, RFFE 1124, and antenna panels 1126. In some embodiments, the transmit components of the UE 1104 may apply a spatial filter to the data to be transmitted to form a transmit beam emitted by the antenna elements of the antenna panels 1126.

Similar to the UE 1102, the AN 1104 may include a host platform 1128 coupled with a modem platform 1130. The host platform 1128 may include application processing circuitry 1132 coupled with protocol processing circuitry 1134 of the modem platform 1130. The modem platform may further include digital baseband circuitry 1136, transmit circuitry 1138, receive circuitry 1140, RF circuitry 1142, RFFE circuitry 1144, and antenna panels 1146. The components of the AN 1104 may be similar to and substantially interchangeable with like-named components of the UE 1102. In addition to performing data transmission/reception as described above, the components of the AN 1108 may perform various logical functions that include, for example, RNC functions such as radio bearer management, uplink and downlink dynamic radio resource management, and data packet scheduling.

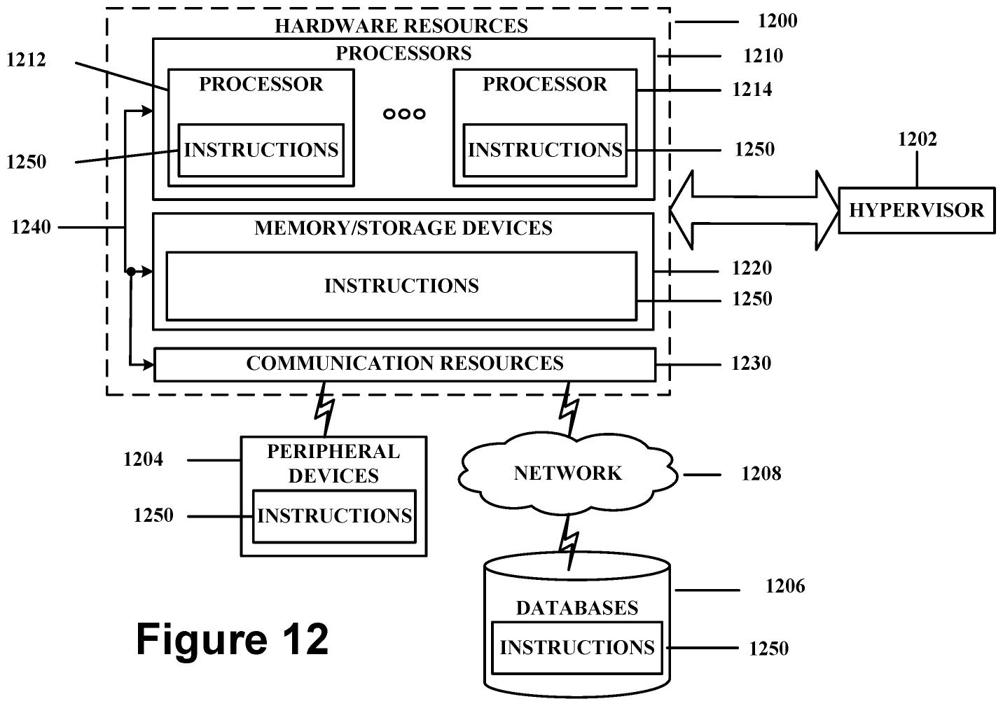

FIG. 12 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1200 including one or more processors (or processor cores) 1210, one or more memory/storage devices 1220, and one or more communication resources 1230, each of which may be communicatively coupled via a bus 1240 or other interface circuitry. For embodiments where node virtualization (e.g., NFV) is utilized, a hypervisor 1202 may be executed to provide an execution environment for one or more network slices/sub-slices to utilize the hardware resources 1200.

The processors 1210 may include, for example, a processor 1212 and a processor 1214. The processors 1210 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radiofrequency integrated circuit (RFIC), another processor (including those discussed herein), or any suitable combination thereof.

The memory/storage devices 1220 may include main memory, disk storage, or any suitable combination thereof. The memory/storage devices 1220 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1230 may include interconnection or network interface controllers, components, or other suitable devices to communicate with one or more peripheral devices 1204 or one or more databases 1206 or other network elements via a network 1208. For example, the communication resources 1230 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1250 may comprise software, a program, an application, an applet, an app, or other executable code for causing at least any of the processors 1210 to perform any one or more of the methodologies discussed herein. The instructions 1250 may reside, completely or partially, within at least one of the processors 1210 (e.g., within the processor's cache memory), the memory/storage devices 1220, or any suitable combination thereof. Furthermore, any portion of the instructions 1250 may be transferred to the hardware resources 1200 from any combination of the peripheral devices 1204 or the databases 1206. Accordingly, the memory of processors 1210, the memory/storage devices 1220, the peripheral devices 1204, and the databases 1206 are examples of computer-readable and machine-readable media.

### Example Procedures

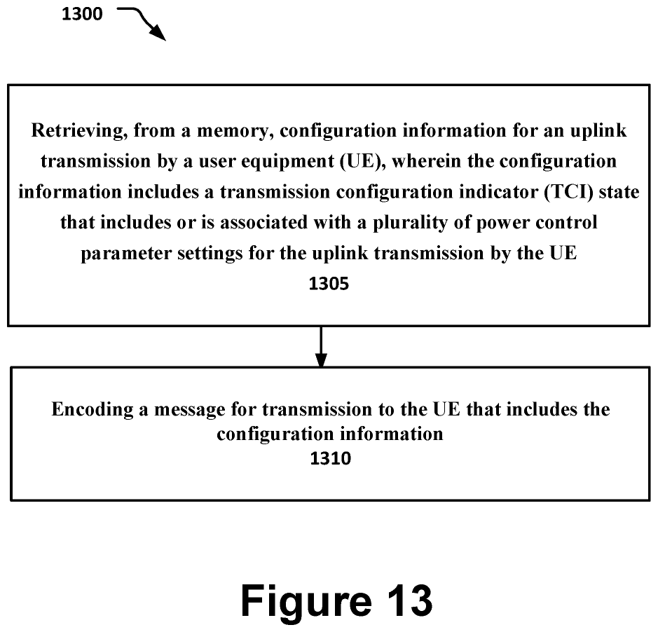

In some embodiments, the electronic device(s), network(s), system(s), chip(s) or component(s), or portions or implementations thereof, of FIGS. 10-12, or some other figure herein, may be configured to perform one or more processes, techniques, or methods as described herein, or portions thereof. One such process is depicted in FIG. 13, which may be performed by a next-generation NodeB (gNB) or portion thereof in some embodiments. In this example, process 1300 includes, at 1305, retrieving, from a memory, configuration information for an uplink transmission by a user equipment (UE), wherein the configuration information includes a transmission configuration indicator (TCI) state that includes or is associated with a plurality of power control parameter settings for the uplink transmission by the UE. The process further includes, at 1310, encoding a message for transmission to the UE that includes the configuration information.

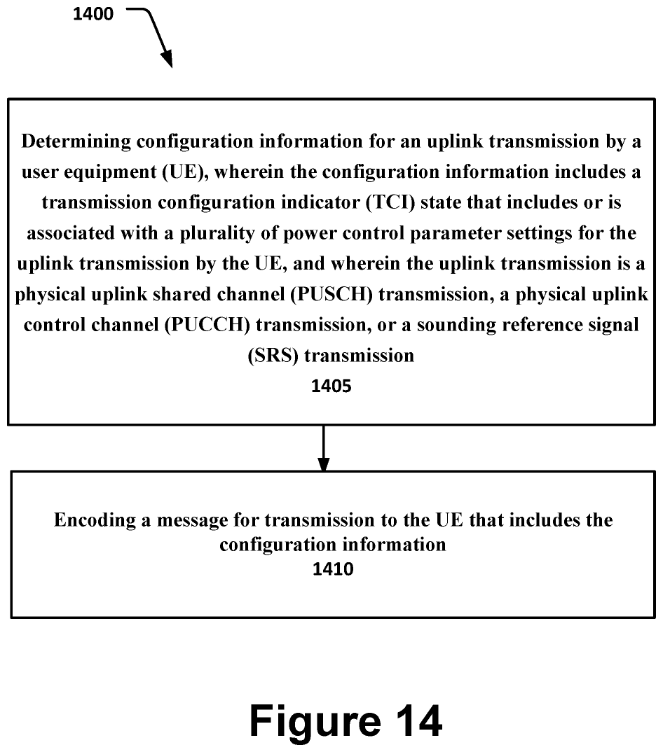

Another such example is illustrated in FIG. 14. In this example, process 1400 includes, at 1405, determining configuration information for an uplink transmission by a user equipment (UE), wherein the configuration information includes a transmission configuration indicator (TCI) state that includes or is associated with a plurality of power control parameter settings for the uplink transmission by the UE, and wherein the uplink transmission is a physical uplink shared channel (PUSCH) transmission, a physical uplink control channel (PUCCH) transmission, or a sounding reference signal (SRS) transmission. The process further includes, at 1410, encoding a message for transmission to the UE that includes the configuration information.

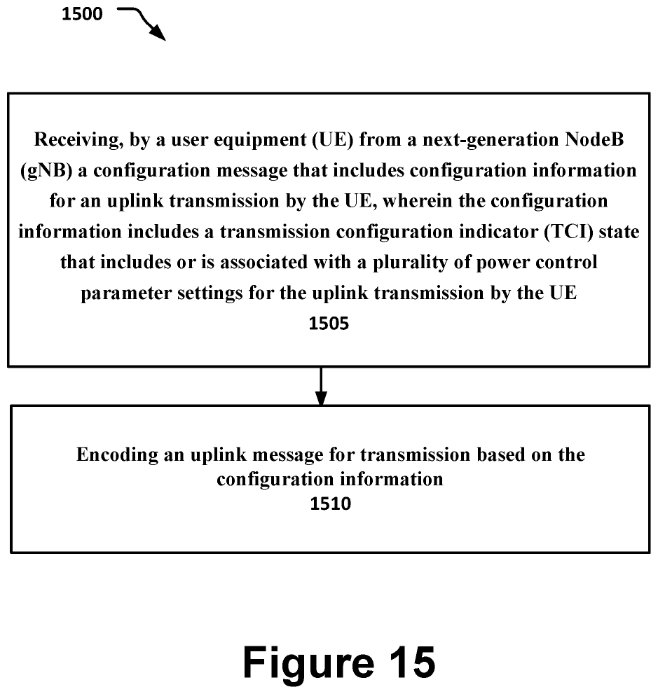

Another such example is illustrated in FIG. 15. In this example, process 1500 includes, at 1505, receiving, by a user equipment (UE) from a next-generation NodeB (gNB) a configuration message that includes configuration information for an uplink transmission by the UE, wherein the configuration information includes a transmission configuration indicator (TCI) state that includes or is associated with a plurality of power control parameter settings for the uplink transmission by the UE. The process further includes, at 1510, encoding an uplink message for transmission based on the configuration information.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 May Include a Method Wherein the gNB Configures the UE with SRS for Antenna Switching.

Example 2 may include the method of example 1 or some other example herein, wherein for SRS with antenna switching, only one group of SRS resource sets is configured for certain xTyR configuration in multi-TRP, which means the number of SRS resource sets (including periodic/semi-persistent/aperiodic SRS) for xTyR in multi-TRP is the same as the case of xTyR in single TRP. In this case, multiple (e.g. 2) separate close loop power control states could be configured for SRS (one separate close loop power control state corresponds to one TRP). Or only one separate close loop power control state could be configured for SRS.

Example 3 may include the method of example 2 or some other example herein, wherein for SRS with antenna switching, if the UE supports joint DL/UL TCI state, the SRS power control parameter setting (P0, alpha, closed loop power control index/closed loop power control state, pathloss reference signal, etc.) could be associated/included in the joint DL/UL TCI state. The association between TCI state and SRS power control settings could be configured by RRC or updated by MAC-CE. In another example, the pathloss reference signal is configured by RRC or updated by MAC-CE.

Example 4 may include the method of example 2 or some other example herein, wherein for SRS with antenna switching, if the UE supports separate DL/UL TCI state, the SRS power control parameter setting (P0, alpha, closed loop power control index/closed loop power control state, pathloss reference signal, etc.) could be associated/included in the separate DL TCI state. The association between TCI state and SRS power control settings could be configured by RRC or updated by MAC-CE. In another example, the pathloss reference signal is configured by RRC or updated by MAC-CE. In this case, both spatial relation and power control setting for SRS is obtained from the separate DL TCI state

Example 5 may include the method of example 2 or some other example herein, wherein for SRS with antenna switching, if the UE supports separate DL/UL TCI state, the SRS power control parameter setting (P0, alpha, closed loop power control index/closed loop power control state, pathloss reference signal, etc.) could be associated/included in the separate UL TCI state. The association between TCI state and SRS power control settings could be configured by RRC or updated by MAC-CE. In another example, the pathloss reference signal is configured by RRC or updated by MAC-CE. For SRS with antenna switching, the spatial relation for SRS is determined by the separate DL TCI state. The power control setting is derived from the separate UL TCI state.

Example 6 may include the method of example 1 or some other example herein, wherein for SRS with antenna switching, two groups of SRS resource sets are configured for certain xTyR configuration in multi-TRP, which means the number of SRS resource sets (including periodic/semi-persistent/aperiodic SRS) for xTyR in multi-TRP is doubled as the case of xTyR in single TRP. In this case, multiple (e.g. 2) separate close loop power control states could be configured for SRS (one separate close loop power control state corresponds to one TRP). One group of SRS resource sets is configured with the first close loop power control state. The other group of SRS resource sets is configured with the second close loop power control state. Or only one separate close loop power control state could be configured for SRS.

Example 7 may include the method of example 6 or some other example herein, wherein for SRS with antenna switching, if the UE supports joint DL/UL TCI state, the SRS power control parameter setting (P0, alpha, closed loop power control index/closed loop power control state, pathloss reference signal, etc.) could be associated/included in the joint DL/UL TCI state. The association between TCI state and SRS power control settings could be configured by RRC or updated by MAC-CE. In another example, the pathloss reference signal is configured by RRC or updated by MAC-CE.

Example 8 may include the method of example 6 or some other example herein, wherein for SRS with antenna switching, if the UE supports separate DL/UL TCI state, the SRS power control parameter setting (P0, alpha, closed loop power control index/closed loop power control state, pathloss reference signal, etc.) could be associated/included in the separate UL TCI state. The association between TCI state and SRS power control settings could be configured by RRC or updated by MAC-CE. In another example, the pathloss reference signal is configured by RRC or updated by MAC-CE.

Example 9 may include the method of example 1 or some other example herein, wherein if the UE doesn't support joint DL/UL TCI or separate DL/UL TCI state, the SRS power control parameter setting (P0, alpha, closed loop power control index/closed loop power control state, pathloss reference signal, etc.) could be updated by MAC-CE.

Example 10 may include a method wherein the gNB configures the UE with SRS for beam management.

Example 11 may include the method of example 10 or some other example herein, wherein the SRS is to refine UE Tx beam.

Example 12 may include the method of example 11 or some other example herein, wherein for SRS with beam management, if the UE supports joint DL/UL TCI state, the SRS power control parameter setting (P0, alpha, closed loop power control index/closed loop power control state, pathloss reference signal, etc.) could be associated/included in the joint DL/UL TCI state. The association between TCI state and SRS power control settings could be configured by RRC or updated by MAC-CE. In another example, the pathloss reference signal is configured by RRC or updated by MAC-CE.

Example 13 may include the method of example 11 or some other example herein, wherein for SRS with beam management, if the UE supports separate DL/UL TCI state, the SRS power control parameter setting (P0, alpha, closed loop power control index/closed loop power control state, pathloss reference signal, etc.) could be associated/included in the separate UL TCI state. The association between TCI state and SRS power control settings could be configured by RRC or updated by MAC-CE. In another example, the pathloss reference signal is configured by RRC or updated by MAC-CE.

Example 14 may include the method of example 10 or some other example herein, wherein the SRS is to refine gNB Rx beam.

Example 15 may include the method of example 14 or some other example herein, wherein for SRS with beam management, if the UE supports joint DL/UL TCI state, the SRS power control parameter setting (P0, alpha, closed loop power control index/closed loop power control state, pathloss reference signal, etc.) could be associated/included in the joint DL/UL TCI state. The association between TCI state and SRS power control settings could be configured by RRC or updated by MAC-CE. In another example, the pathloss reference signal is configured by RRC or updated by MAC-CE.

Example 16 may include the method of example 14 or some other example herein, wherein for SRS with beam management, if the UE supports separate DL/UL TCI state, the SRS power control parameter setting (P0, alpha, closed loop power control index/closed loop power control state, pathloss reference signal, etc.) could be associated/included in the separate UL TCI state. The association between TCI state and SRS power control settings could be configured by RRC or updated by MAC-CE. In another example, the pathloss reference signal is configured by RRC or updated by MAC-CE.

Example 17 may include the method of example 14 or some other example herein, wherein if the UE doesn't support joint DL/UL TCI or separate DL/UL TCI state, the SRS power control parameter setting (P0, alpha, closed loop power control index/closed loop power control state, pathloss reference signal, etc.) could be updated by MAC-CE.

Example 18 may include the method of example 1 and example 10 or some other example herein, wherein in multi-TRP operation, the UE could be configured with multiple separate close loop power control state, e.g. one or some SRS resource sets is configured with the first separate close loop power control state, the other one or some SRS resource sets is configured with the second separate close loop power control state. The separate power control state could be used for any or some specific usage, e.g. antenna switching/beam management, wherein the SRS power control is not tied with PUSCH. The SRS could be periodic/semi-persistent/aperiodic. The different separate close loop power control state corresponds to different TRP. The power control state could be configured by RRC or updated by MAC-CE or changed by DCI.

Example 19 may include a method of a UE, the method comprising:
receiving configuration information for transmission of SRS with antenna switching, wherein only one SRS resource set is configured for a xTyR configuration associated with multi-TRP communication; and
encoding an SRS for transmission based on the configuration information.

Example 20 may include the method of example 19 or some other example herein, further comprising receiving configuration of multiple close loop power control states for different TRPs of the multi-TRP communication.

Example 21 may include the method of example 19-20 or some other example herein, wherein one or more SRS power control parameters are indicated by a joint DL/UL TCI state.

Example 22 may include the method of example 21 or some other example herein, wherein the one or more SRS power control parameters include one or more of a power offset, an alpha value, a closed loop power control index, a closed loop power control state, and/or a pathloss reference signal.

Example X1 may include a method wherein a gNB configures a UE with SRS for codebook.

Example X2 may include the method of example X1 or some other example herein, wherein for UE supporting joint DL/UL TCI or separate DL/UL TCI state, the SRS power control parameter setting (P0, alpha, closed loop power control index/closed loop power control state, pathloss reference signal, etc.) could be associated/included in the TCI state. The association between TCI state and SRS power control settings could be configured by RRC or updated by MAC-CE. (In one example, the TCI state could be joint DL/UL TCI state or separate UL TCI state.) When the TCI state is indicated via DCI (e.g. DCI format 1_1/1_2 or any other DCI format that can indicate TCI state), the application of TCI state and corresponding power control settings to the SRS resource set is implicitly indicated by the closed loop power control index, e.g. the TCI state and power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI. Similarly, the application of TCI state and corresponding power control settings to PUSCH repetition/PUCCH repetition is implicitly indicated by the closed loop power control index, e.g. the TCI state and power control setting will be applied to the PUSCH repetition/PUCCH repetition with the same closed loop power control index (targeting to the same TRP).

Example X3 may include the method of example X2 or some other example herein, wherein the same TCI state could be associated with or could include different power control parameter settings (P0, alpha, closed loop power control index/closed loop power control state, pathloss reference signal, etc.) for PUSCH/PUCCH/SRS. In this way, when one TCI state is indicated, different parameter settings could be applied for PUSCH, PUCCH and SRS.

Example X4 may include the method of example X1 or some other example herein, wherein the power control setting for PUSCH/PUCCH/SRS is not associated with the TCI state. In one example, the TCI state is associated with closed loop power control index. The mapping between TCI state and PUSCH repetition/PUCCH repetition/SRS resource set could be via the close loop index, e.g. the TCI state could be applied for the PUSCH/PUCCH/SRS with the same closed loop index. In another example, the TCI state is implicitly associated with closed loop power control index. For example, in multi-TRP case, the first TCI state in the DCI is implicitly associated with the 1st TRP (the 1st closed loop power control index), and the second TCI state in the DCI is implicitly associated with the 2nd TRP (the 2nd closed loop power control index).

Example X5 may include the method of example X1 or some other example herein, wherein for UE supporting joint DL/UL TCI or separate DL/UL TCI state, for SRS configured with usage of codebook, up to two different TCI state could be applied for the SRS resources within the same SRS resource set if the number of SRS resources is larger than or equal to 2.

Example X6 may include the method of example X1 or some other example herein, wherein if the UE doesn't support joint DL/UL TCI or separate DL/UL TCI state, the SRS power control parameter setting (P0, alpha, closed loop power control index/closed loop power control state, pathloss reference signal, etc.) could be updated by MAC-CE.

Example X7 may include a method wherein a gNB configures a UE with SRS for non-codebook.

Example X8 may include the method of example X7 or some other example herein, wherein if the associated CSI-RS is configured for SRS with usage of non-codebook, for UE supporting joint DL/UL TCI or separate DL/UL TCI state, the SRS power control parameter setting (P0, alpha, closed loop power control index/closed loop power control state, etc.) could be associated/included in the TCI state. The association between TCI state and SRS power control settings could be configured by RRC or updated by MAC-CE. (In one example, the TCI state could be joint DL/UL TCI state or separate UL TCI state.) When the TCI state is indicated via DCI (e.g. DCI format 1_1/1_2 or any other DCI format that can indicate TCI state), the application of TCI state and corresponding power control settings to the SRS resource set is implicitly indicated by the closed loop power control index, e.g. the TCI state and power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI.

Example X9 may include the method of example X8 or some other example herein, wherein for non-codebook SRS, the pathloss reference signal could be the associated CSI-RS or could be QCLed with the associated with the associated CSI-RS. The pathloss reference signal could be RRC configured and updated by MAC-CE. Or the pathloss reference signal for SRS could also be associated with the TCI state.

Example X10 may include the method of example X8 or some other example herein, wherein the same TCI state could be associated with or could include different power control parameter settings (P0, alpha, closed loop power control index/closed loop power control state, etc.) for PUSCH/PUCCH/SRS. In this way, when one TCI state is indicated, different parameter settings could be applied for PUSCH, PUCCH and SRS.

Example X11 may include the method of example X7 or some other example herein, wherein if the associated CSI-RS is configured for SRS with usage of non-codebook, the power control setting for PUSCH/PUCCH/SRS is not associated with the TCI state. In one example, the TCI state is associated with closed loop power control index. The mapping between TCI state and PUSCH repetition/PUCCH repetition/SRS resource set could be via the close loop index, e.g. the TCI state could be applied for the PUSCH/PUCCH/SRS with the same closed loop index. In another example, the TCI state is implicitly associated with closed loop power control index. For example, in multi-TRP case, the first TCI state in the DCI is implicitly associated with the 1st TRP (the 1st closed loop power control index), and the second TCI state in the DCI is implicitly associated with the 2nd TRP (the 2nd closed loop power control index).

Example X12 may include the method of example X7 or some other example herein, wherein if the associated CSI-RS is not configured for SRS with usage of non-codebook, for UE supporting joint DL/UL TCI or separate DL/UL TCI state, the SRS power control parameter setting (P0, alpha, closed loop power control index/closed loop power control state, pathloss reference signal, etc.) could be associated/included in the TCI state. The association between TCI state and SRS power control settings could be configured by RRC or updated by MAC-CE. (In one example, the TCI state could be joint DL/UL TCI state or separate UL TCI state.) When the TCI state is indicated via DCI (e.g. DCI format 1_1/1_2 or any other DCI format that can indicate TCI state), the application of TCI state and corresponding power control settings to the SRS resource set is implicitly indicated by the closed loop power control index, e.g. the TCI state and power control setting will be applied to the SRS resource set configured with the same closed loop power control index. The SRS resource set could be periodic/semi-persistent/aperiodic. The closed loop power control index for SRS resource set could be configured by RRC and/or updated/changed by MAC-CE or DCI.

Example X13 may include the method of example X12 or some other example herein, wherein the same TCI state could be associated with or could include different power control parameter settings (P0, alpha, closed loop power control index/closed loop power control state, pathloss reference signal, etc.) for PUSCH/PUCCH/SRS. In this way, when one TCI state is indicated, different parameter settings could be applied for PUSCH, PUCCH and SRS.

Example X14 may include the method of example X7 or some other example herein, wherein if the associated CSI-RS is not configured for SRS with usage of non-codebook, the power control setting for PUSCH/PUCCH/SRS is not associated with the TCI state. In one example, the TCI state is associated with closed loop power control index. The mapping between TCI state and PUSCH repetition/PUCCH repetition/SRS resource set could be via the close loop index, e.g. the TCI state could be applied for the PUSCH/PUCCH/SRS with the same closed loop index. In another example, the TCI state is implicitly associated with closed loop power control index. For example, in multi-TRP case, the first TCI state in the DCI is implicitly associated with the 1st TRP (the 1st closed loop power control index), and the second TCI state in the DCI is implicitly associated with the 2nd TRP (the 2nd closed loop power control index).

Example X15 may include the method of example X7 or some other example herein, wherein if the UE doesn't support joint DL/UL TCI or separate DL/UL TCI state, the SRS power control parameter setting (P0, alpha, closed loop power control index/closed loop power control state, pathloss reference signal, etc.) could be updated by MAC-CE.

Example X16 may include a method of a UE, the method comprising:
receiving configuration information that indicates an association between TCI states and respective values of one or more sounding reference signal (SRS) power control parameters;
receiving an indication of a first TCI state for an SRS;
determining a first SRS power control parameter for the SRS based on the first TCI state and the configuration information; and
encoding the SRS for transmission based on the first SRS power control parameter.

Example X17 may include the method of example X16 or some other example herein, wherein the one or more SRS power control parameters include one or more of a power offset (P0), alpha, a closed loop power control index, a closed loop power control state, and/or a pathloss reference signal.

Example X18 may include the method of example X16-X17 or some other example herein, wherein the configuration information is received RRC signaling and/or MAC CE.

Example X19 may include the method of example X16-X18 or some other example herein, wherein the indication of the first TCI state is included in a DCI.

Example X20 may include the method of example X19 or some other example herein, wherein the DCI triggers the transmission of the SRS.

Example X21 may include the method of example X16-X20 or some other example herein, wherein the SRS configuration information is for codebook SRS.

Example X22 may include the method of example X16-X21 or some other example herein, wherein the SRS configuration information is for non-codebook SRS.

Example X23 may include the method of example X16-X22 or some other example herein, wherein the configuration information indicates different power control settings associated with the first TCI state for PUSCH repetition and/or PUCCH repetition than for the first SRS.

Example X24 may include a method of a gNB, the method comprising:
encoding, for transmission to a UE, configuration information that indicates an association between TCI states and respective values of one or more sounding reference signal (SRS) power control parameters;
encoding, for transmission to the UE, an indication of a first TCI state to indicate a first SRS power control parameter for an SRS based on the configuration information; and
receiving the SRS from the UE.

Example X25 may include the method of example X24 or some other example herein, wherein the one or more SRS power control parameters include one or more of a power offset (P0), alpha, a closed loop power control index, a closed loop power control state, and/or a pathloss reference signal.

Example X26 may include the method of example X24-X25 or some other example herein, wherein the configuration information is transmitted via RRC signaling and/or a MAC CE.

Example X27 may include the method of example X24-X26 or some other example herein, wherein the indication of the first TCI state is included in a DCI.

Example X28 may include the method of example X27 or some other example herein, wherein the DCI triggers the transmission of the SRS.

Example X29 may include the method of example X24-X28 or some other example herein, wherein the SRS configuration information is for codebook SRS.

Example X30 may include the method of example X24-X29 or some other example herein, wherein the SRS configuration information is for non-codebook SRS.

Example X31 may include the method of example X24-X30 or some other example herein, wherein the configuration information indicates different power control settings associated with the first TCI state for PUSCH repetition and/or PUCCH repetition than for the first SRS.

Example Y1 includes an apparatus comprising:
memory to store configuration information for an uplink transmission by a user equipment (UE); and
processing circuitry, coupled with the memory, to:
   retrieve the configuration information from the memory, wherein the configuration information includes a transmission configuration indicator (TCI) state that includes or is associated with a plurality of power control parameter settings for the uplink transmission by the UE; and
   encode a message for transmission to the UE that includes the configuration information.

Example Y2 includes the apparatus of example Y1 or some other example herein, wherein the plurality of power control parameter settings include one or more of: P0, alpha, a closed loop power control index, a closed loop power control state, or a pathloss reference signal.

Example Y3 includes the apparatus of example Y1 or some other example herein, wherein the uplink transmission is a physical uplink shared channel (PUSCH) transmission, a physical uplink control channel (PUCCH) transmission, or a sounding reference signal (SRS) transmission.

Example Y4 includes the apparatus of example Y1 or some other example herein, wherein the message is encoded for transmission to the UE via radio resource control (RRC) signaling.

Example Y5 includes the apparatus of example Y1 or some other example herein, wherein the processing circuitry is further to update an association between the TCI state the plurality of power control parameter settings for the uplink transmission using a medium access control (MAC) control element (CE).

Example Y6 includes the apparatus of example Y1 or some other example herein, wherein the configuration information includes at least one power control parameter setting that is common to a plurality of different uplink transmissions.

Example Y7 includes the apparatus of any of examples Y1-Y6 or some other example herein, wherein the uplink transmission is associated with a codebook.

Example Y8 includes the apparatus of any of examples Y1-Y6 or some other example herein, wherein the uplink transmission is not associated with a codebook.

Example Y9 includes one or more computer-readable media storing instructions that, when executed by one or more processors, cause a next-generation NodeB (gNB) to:
determine configuration information for an uplink transmission by a user equipment (UE), wherein the configuration information includes a transmission configuration indicator (TCI) state that includes or is associated with a plurality of power control parameter settings for the uplink transmission by the UE, and wherein the uplink transmission is a physical uplink shared channel (PUSCH) transmission, a physical uplink control channel (PUCCH) transmission, or a sounding reference signal (SRS) transmission; and
encode a message for transmission to the UE that includes the configuration information.

Example Y10 includes the one or more computer-readable media of example Y9 or some other example herein, wherein the plurality of power control parameter settings include one or more of: P0, alpha, a closed loop power control index, a closed loop power control state, or a pathloss reference signal.

Example Y11 includes the one or more computer-readable media of example Y9 or some other example herein, wherein the message is encoded for transmission to the UE via radio resource control (RRC) signaling.

Example Y12 includes the one or more computer-readable media of example Y9 or some other example herein, wherein the media further stores instructions to update an association between the TCI state the plurality of power control parameter settings for the uplink transmission using a medium access control (MAC) control element (CE).

Example Y13 includes the one or more computer-readable media of example Y9 or some other example herein, wherein the configuration information includes at least one power control parameter setting that is common to a plurality of different uplink transmissions.

Example Y14 includes the one or more computer-readable media of any of examples Y9-Y13 or some other example herein, wherein the uplink transmission is associated with a codebook.

Example Y15 includes the one or more computer-readable media of any of examples Y9-Y13 or some other example herein, wherein the uplink transmission is not associated with a codebook.

Example Y16 includes one or more computer-readable media storing instructions that, when executed by one or more processors, cause a user equipment (UE) to:
receive, from a next-generation NodeB (gNB) a configuration message that includes configuration information for an uplink transmission by the UE, wherein the configuration information includes a transmission configuration indicator (TCI) state that includes or is associated with a plurality of power control parameter settings for the uplink transmission by the UE; and
encode an uplink message for transmission based on the configuration information.

Example Y17 includes the one or more computer-readable media of example Y16 or some other example herein, wherein the plurality of power control parameter settings include one or more of: P0, alpha, a closed loop power control index, a closed loop power control state, or a pathloss reference signal.

Example Y18 includes the one or more computer-readable media of example Y16 or some other example herein, wherein the uplink transmission is a physical uplink shared channel (PUSCH) transmission, a physical uplink control channel (PUCCH) transmission, or a sounding reference signal (SRS) transmission.

Example Y19 includes the one or more computer-readable media of example Y16 or some other example herein, wherein the configuration message is received from the gNB via radio resource control (RRC) signaling.

Example Y20 includes the one or more computer-readable media of example Y16 or some other example herein, wherein the media further stores instructions to receive, from the gNB, an update to an association between the TCI state the plurality of power control parameter settings for the uplink transmission using a medium access control (MAC) control element (CE).

Example Y21 includes the one or more computer-readable media of example Y16 or some other example herein, wherein the configuration information includes at least one power control parameter setting that is common to a plurality of different uplink transmissions.

Example Y22 includes the one or more computer-readable media of any of examples Y16-Y21 or some other example herein, wherein the uplink transmission is associated with a codebook.

Example Y23 includes the one or more computer-readable media of any of examples Y16-Y21 or some other example herein, wherein the uplink transmission is not associated with a codebook.

Example Z01 may include an apparatus comprising means to perform one or more elements of a method described in or related to any of examples 1-Y23, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-Y23, or any other method or process described herein.

Example Z03 may include an apparatus comprising logic, modules, or circuitry to perform one or more elements of a method described in or related to any of examples 1-Y23, or any other method or process described herein.

Example Z04 may include a method, technique, or process as described in or related to any of examples 1-Y23, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-Y23, or portions thereof.

Example Z06 may include a signal as described in or related to any of examples 1-Y23, or portions or parts thereof.

Example Z07 may include a datagram, packet, frame, segment, protocol data unit (PDU), or message as described in or related to any of examples 1-Y23, or portions or parts thereof, or otherwise described in the present disclosure.

Example Z08 may include a signal encoded with data as described in or related to any of examples 1-Y23, or portions or parts thereof, or otherwise described in the present disclosure.

Example Z09 may include a signal encoded with a datagram, packet, frame, segment, protocol data unit (PDU), or message as described in or related to any of examples 1-Y23, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-Y23, or portions thereof.

Example Z11 may include a computer program comprising instructions, wherein execution of the program by a processing element is to cause the processing element to carry out the method, techniques, or process as described in or related to any of examples 1-Y23, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACR | Application Context Relocation |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AOA | Angle of Arrival |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CDR | Charging Data Request |
| CDR | Charging Data Response |
| CFRA | Contention Free Random Access |
| CG | Cell Group |
| CGF | Charging Gateway Function |
| CHF | Charging Function |
| CI | Cell Identity |
| CID | Cell-ID (e g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further |
| | enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access |
| | Network |
| GGSN | Gateway GPRS Support Node |
| GLONASS | GLObal'naya NAvigatsionnaya Sputnikovaya |
| | Sistema (Engl.: Global Navigation Satellite System) |
| gNB | Next Generation NodeB |
| gNB-CU | gNB-centralized unit, Next Generation NodeB |
| | centralized unit |
| gNB-DU | gNB-distributed unit, Next Generation NodeB |
| | distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Spécial Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is |
| | http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IIOT | Industrial Internet of Things |
| IM | Interference Measurement, Intermodulation, IP |
| | Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LMF | Location Management Function |
| LOS | Line of Sight |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec |
| | Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-I | MAC used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management |
| | Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTCmassive | MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non- Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control |
| | layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time Rx Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame |
| | timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | SS/PBCH Block Resource Indicator, Synchronization |
| Block SSBRI | Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, VLAN Virtual LAN, Virtual Local |
| | Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over- Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-23. (canceled)

24. An apparatus comprising:
memory to store configuration information for an uplink transmission by a user equipment (UE); and
processor circuitry, coupled with the memory, to:
retrieve the configuration information from the memory, wherein the configuration information includes a transmission configuration indicator (TCI) state that includes or is associated with a plurality of power control parameter settings for the uplink transmission by the UE; and
encode a message for transmission to the UE that includes the configuration information.

25. The apparatus of claim 24, wherein the plurality of power control parameter settings include one or more of: P0, alpha, a closed loop power control index, a closed loop power control state, or a pathloss reference signal.

26. The apparatus of claim 24, wherein the uplink transmission is a physical uplink shared channel (PUSCH) transmission, a physical uplink control channel (PUCCH) transmission, or a sounding reference signal (SRS) transmission.

27. The apparatus of claim 24, wherein the message is encoded for transmission to the UE via radio resource control (RRC) signaling.

28. The apparatus of claim 24, wherein the processor circuitry is further to update an association between the TCI state the plurality of power control parameter settings for the uplink transmission using a medium access control (MAC) control element (CE).

29. The apparatus of claim 24, wherein the configuration information includes at least one power control parameter setting that is common to a plurality of different uplink transmissions.

30. The apparatus of claim 24, wherein the uplink transmission is associated with a codebook.

31. The apparatus of claim 24, wherein the uplink transmission is not associated with a codebook.

32. One or more non-transitory computer-readable media storing instructions that, when executed by one or more processors, cause a next-generation NodeB (gNB) to:
determine configuration information for an uplink transmission by a user equipment (UE), wherein the configuration information includes a transmission configuration indicator (TCI) state that includes or is associated with a plurality of power control parameter settings for the uplink transmission by the UE, and wherein the uplink transmission is a physical uplink shared channel (PUSCH) transmission, a physical uplink control channel (PUCCH) transmission, or a sounding reference signal (SRS) transmission; and
encode a message for transmission to the UE that includes the configuration information.

33. The one or more non-transitory computer-readable media of claim 32, wherein the plurality of power control parameter settings include one or more of: P0, alpha, a closed loop power control index, a closed loop power control state, or a pathloss reference signal.

34. The one or more non-transitory computer-readable media of claim 32, wherein the message is encoded for transmission to the UE via radio resource control (RRC) signaling.

35. The one or more non-transitory computer-readable media of claim 32, wherein the media further stores instructions that when executed cause the gNB to update an association between the TCI state the plurality of power control parameter settings for the uplink transmission using a medium access control (MAC) control element (CE).

36. The one or more non-transitory computer-readable media of claim 32, wherein the configuration information includes at least one power control parameter setting that is common to a plurality of different uplink transmissions.

37. The one or more non-transitory computer-readable media of claim 32, wherein the uplink transmission is associated with a codebook or is not associated with a codebook.

38. One or more non-transitory computer-readable media storing instructions that, when executed by one or more processors, cause a user equipment (UE) to:
receive, from a next-generation NodeB (gNB) a configuration message that includes configuration information for an uplink transmission by the UE, wherein the configuration information includes a transmission configuration indicator (TCI) state that includes or is associated with a plurality of power control parameter settings for the uplink transmission by the UE; and
encode an uplink message for transmission based on the configuration information.

39. The one or more non-transitory computer-readable media of claim 38, wherein the plurality of power control parameter settings include one or more of: P0, alpha, a closed loop power control index, a closed loop power control state, or a pathloss reference signal.

40. The one or more non-transitory computer-readable media of claim 38, wherein the uplink transmission is a physical uplink shared channel (PUSCH) transmission, a physical uplink control channel (PUCCH) transmission, or a sounding reference signal (SRS) transmission.

41. The one or more non-transitory computer-readable media of claim 38, wherein the media further stores instructions that when executed cause the UE to receive, from the gNB, an update to an association between the TCI state the plurality of power control parameter settings for the uplink transmission using a medium access control (MAC) control element (CE).

42. The one or more non-transitory computer-readable media of claim 38, wherein the configuration information includes at least one power control parameter setting that is common to a plurality of different uplink transmissions.

43. The one or more non-transitory computer-readable media of claim 38, wherein the uplink transmission is associated with a codebook or is not associated with a codebook.
